(19) United States
(12) Patent Application Publication
(10) Pub. No.: US 2024/0060021 A1
(43) Pub. Date: Feb. 22, 2024

(54) LAUNDRY DETERGENT COMPOSITION

(71) Applicant: The Procter & Gamble Company, Cincinnati, OH (US)

(72) Inventors: Robby Renilde François KEULEERS, Lippelo (Sint-Amands) (BE); Phillip Kyle VINSON, Fairfield, OH (US); Philip Frank SOUTER, Morpeth Northumberland (GB); Marc H. J. STALMANS, Heverlee LeReuven (BE)

(21) Appl. No.: 18/447,358

(22) Filed: Aug. 10, 2023

(30) Foreign Application Priority Data
Aug. 11, 2022 (CA) 3169962

(51) Int. Cl. C11D 11/00; C11D 3/34; C11D 3/50; C11D 17/04

(52) U.S. Cl. CPC C11D 11/0017; C11D 3/349; C11D 3/50; C11D 11/0094; C11D 17/043

(57) ABSTRACT

Laundry detergent compositions, water-soluble unit dose detergent products and methods of making each, are described. The laundry detergent compositions include renewable components, can be biodegradable, have a low carbon footprint and free of materials with a potential hazard concern, while still providing consumer acceptable performance. Packaging containing such laundry detergent compositions or water-soluble unit dose detergent products are also described.

### FIELD OF THE INVENTION

The present disclosure relates to laundry detergent products that comprise more eco-friendly components, both related to the detergent composition as the enclosing packaging material, and methods of making said laundry detergent compositions.

### BACKGROUND OF THE INVENTION

There is increasing consumer and customer demand for laundry detergent products that are environmentally friendly (“eco-friendly”). For example, many consumers are demanding laundry detergent products that have components that are based on renewable carbon, are biodegradable and have a low carbon footprint. There has also been a growing attention towards recyclability of and recycled content in the provided packaging enclosing the laundry detergent product.

There have been great strides in eco-friendly laundry detergents. For example, the introduction of unit dose laundry detergents provides sustainability advantages such as transportation reduction via their more compact form. Additionally, these unit dose laundry detergents reduce the likelihood of in-use over-dosing via their pre-dosed unit form. Also, liquid laundry detergents and granular detergents have compacted over time, reducing their ecological footprint behind a reduced packaging and transportation need. Cleaning performance has also been improved, allowing these products to be used at lower wash temperatures and shorter wash cycles these days compared to the past, saving on consumed energy during a wash cycle accordingly.

Despite these sustainability advantages, consumers are demanding even more in the way of sustainability. For example, liquid laundry detergents (including those of the unit dose form) comprise a blend of surfactants and detergent actives such as solvents, detersive enzymes, polymers, builders and chelants to improve cleaning performance and to achieve compositions that are consumer acceptable. These components are typically synthetic and petroleum-based.

The swapping of petroleum-based components to those which are more eco-friendly is not impossible. However, careful selection of the eco-friendly components is warranted. While consumers are demanding more eco-friendly components, their expectation is that performance of these eco-friendly laundry detergents will be at least on par with the conventional laundry detergents or better. For example, some consumer expectations for these eco-friendly laundry detergents are that they will deliver performance on many attributes, such as cleaning, whiteness, color care, softness, shape retention and freshness, comparable to traditional products, as well as delivering an optimum viscosity profile to balance dosing versus dissolution properties, and physical and chemical stability across storage conditions throughout the lifetime of such liquid laundry detergent product.

With the foregoing in mind, there is a need for laundry detergent compositions that include renewable components, are biodegradable, and have a low carbon footprint, while still providing consumer acceptable performance.

### BRIEF SUMMARY OF THE INVENTION

The laundry detergent products of the present disclosure are eco-friendly in their formulation and/or packaging. A first aspect of the present disclosure, is a laundry detergent composition, wherein the laundry detergent composition, its individual starting materials and/or eventual premixes created thereof, or mixtures thereof, to make the laundry detergent composition, has one or more of the following properties:
a. from 10 to 100 percent by weight carbon-containing components, wherein the carbon associated with those components comprises from about 10 percent, or from about 20 percent or from about 30 percent, of from about 40 percent or from about 50 percent, to about 60 percent or to about 70 percent or to about 80 percent or to about 90 percent, or to about 100 percent by weight renewable carbon.
b. comprises from about 1 percent, or from about 5 percent, or from about 10 percent, or from about 20 percent, or from about 30 percent, of from about 40 percent or from about 50 percent, to about 60 percent or to about 70 percent or to about 80 percent or to about 90 percent, or to about 100 percent by weight of the individual component pre-mixes or final formulations of biodegradable components according to OECD readily biodegradable 301 test protocols, preferably the OECD 301B test protocol (OECD (1992), Test No. 301: Ready Biodegradability, OECD Guidelines for the Testing of Chemicals, Section 3, OECD Publishing, Paris, https://doi.org/10.1787/9789264070349-en.).
c. a carbon footprint expressed in kg CO₂ equivalent/kg of the individual components, pre-mixes or final formulations of less than 10 or less than 3 or less than 2 or less than 1.5 or less than 1 or less than 0.75 or less than 0.5 or less than 0.25 or zero or even a negative footprint.

A second aspect of the present disclosure is a water-soluble unit dose article comprising a water-soluble film and a laundry detergent composition according to the present disclosure.

A third aspect of the present disclosure is a process of making a laundry detergent composition or a water-soluble unit dose article comprising said laundry detergent composition according to the present invention.

A fourth aspect of the present disclosure is a water-soluble foam, fibre or sheet form comprising a laundry detergent composition according to the present invention, optionally in unitized dose.

A fifth aspect of the present disclosure relates to a package or packaging for enclosing the laundry detergent products according to the invention, wherein the packaging has one or more of the following properties:
a. A recycled content of at least 25 percent, preferably at least 50 percent, more preferably at least 75 percent, most preferably 100 percent by weight of the packaging;
b. Compliant with recycling stream requirements, i.e. comprising a recyclable content of greater than 50 percent, preferably more than 60 percent, more than 70 percent, more than 80 percent, more than 90 percent or even more than 95 percent by weight of the packaging of a main packaging material, while comprising less than 50 percent preferably less than 40 percent, or less than 30 percent or less than 20 percent or less than 10 percent or even less than 5 percent by weight of the packaging of secondary packaging materials.

### BRIEF DESCRIPTION OF THE DRAWINGS

FIG. 1 is a water-soluble unit dose article according to the present disclosure.

### DETAILED DESCRIPTION OF THE INVENTION

### Laundry Detergent Composition

The term “anhydrous” refers to liquid compositions containing from about 1 percent to about 20 percent of water by weight of the composition, preferably from about 5 percent to about 15 percent of water. The water can be present in the form of hydrated compounds, i.e. bound water or in the form of free water. The term “aqueous” refers to liquid compositions containing greater than 20 percent of water by weight of the composition, preferably from about 25 percent to about 60 percent of water.

As used herein, the term “biodegradable components” refers to components that have the capacity to be biologically degraded by living organisms down to the base substances such as water, carbon dioxide, methane, basic elements and biomass. “Biodegradability” can be assessed according to OECD readily biodegradable 301 test protocols, preferably the OECD 301B test protocol (OECD (1992), Test No. 301: Ready Biodegradability, OECD Guidelines for the Testing of Chemicals, Section 3, OECD Publishing, Paris, https://doi.org/10.1787/9789264070349-en.).

As used herein, the term “carbon footprint” refers to all greenhouse gas emissions released during a product and/or component life cycle. These greenhouse gas emissions are expressed based on the potency of each greenhouse gas relative to CO₂. The carbon footprint is expressed in CO₂ equivalent/kg of product or component. The carbon footprint can be assessed according to ISO14067:2018 or Greenhouse Gas Protocol “GHG” protocol published by World Resources Institute and World Business Council for Sustainable Development September 2011. Additional details for calculating the carbon footprint or carbon equivalency of a variety of cleaning products is also found at the International Association for Soaps, Detergents and Maintenance Products—Product Environmental Footprint at https://www.aise.eu/our-activities/sustainable-cleaning-78/product-environmental-footprint.aspx and a publication entitled “Product Environmental Footprint Category Rules Household Heavy Duty Liquid Laundry Detergents (HDLLD) for machine wash.” September 2019, version 1.2, available at https://www.aise.eu/our-activities/sustainable-cleaning-78/product-environmental-footprint.aspx

The term ‘laundry detergent composition’ refers both to liquid laundry detergent compositions, granular laundry detergent compositions, and mixtures thereof.

The term ‘granular laundry detergent composition’ refers to laundry detergent compositions comprising a solid, optionally but preferably free-flowing, particulate laundry detergent composition, such as a laundry detergent powder. The granular laundry detergent composition is typically a fully formulated laundry detergent composition, not a portion thereof such as a spray-dried, extruded or agglomerate particle that only forms part of the granular laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more specific ingredient particles.

The term ‘liquid laundry detergent composition’ refers to any detergent composition comprising a liquid composition capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules. Additionally, the term ‘liquid laundry detergent composition’ includes both aqueous and anhydrous detergent compositions.

The term “water-soluble form” refers to a foam, fibre or sheet form comprising laundry detergent composition according to the present disclosure. In such forms, the foam, fiber or sheet are water-soluble. The term “water-soluble form” also includes unit dose applications which are in pre-determined sizes or weights for use.

The term “water-soluble unit dose” refers to, in addition to the “water-soluble form” unit dose described previously, to a pouch or a compartment thereof made using a water-soluble film enclosing the laundry detergent composition, that dissolves or disperses in water to release some or all the contents within the pouch or compartment thereof at some temperature or range of temperatures in the normal operating range of an appliance in which these pouches are utilized, e.g. (ambient to 95° C.). Under other temperatures or conditions of use, however, the pouch or compartment thereof may be insoluble in water, remaining intact for extended periods greater than that of the normal operating regime of the appliance.

As used herein, the term “renewable component” refers to a component that is derived from renewable feedstock and contains renewable carbon. A renewable feedstock is a feedstock that is derived from a renewable resource rather than being geologically derived. A material may be partially renewable (less than 100 percent renewable carbon content, from about 1 percent to about 90 percent renewable carbon content, or from about 1 percent to about 80 percent renewable carbon content, or from about 1 percent to about 60 percent renewable carbon content, or from about 1 percent to about 50 percent renewable carbon content) or can be 100 percent renewable (100 percent renewable carbon content). A renewable feedstock may be blended or chemically reacted with a geologically derived feedstock, resulting in a material with a renewable component and a geologically derived component. The renewable carbon content can comprise one or more of the following or mixtures thereof:
(a) Ingredients fully or partly derived from biomass, include food crops, non-food crops, side streams, by-products and biogenic waste;
(b) Ingredients that are fully or partly bio-based;
(c) Ingredients that are fully or partly made by carbon capture and usage (CCU) wherein said captured carbon can be carbon dioxide or methane;
(d) Ingredients that are fully or partly mechanically or chemically recycled (e.g. plastic, tires);
(e) Ingredients that are fully or partly made by conversion of waste chemicals such as plastic or rubber pyrolysis.

As used herein, the term “biomass derived” refers to materials derived from a first, second or third generation biomass. First generation biomass is derived from vegetable oil, starch or sugar coming from an existing row crop. Second generation biomass is derived from cellulosic biomass sources including crop residues, rotational crops, perennial grasses, forestry residues, waste oils and fats such as used cooking oils (UCO), animal fats, crude tall oil (CTO), or Distillers Corn Oil (DCO) and trees. Second generation biomass sources may be grown on marginal cropland where row crop production is not profitable. By focusing on areas that are highly erodible or have marginal soil quality, this avoids competition with fertile ground that may be best used to grow food crops. Third generation biomass or oil includes oils harvested from algae and solid waste biomass.

As used herein, the term “bio-based” refers to the feedstock that a material is made from. Biobased materials are made from renewable (non-petroleum) based sources (plants and animals and/or micro-organisms). Some plants that are used to make bio-based materials include sugarcane, cassava, soy-beans, sugar beets, palm, coconut, rapeseed, canola, algae, switchgrass, camelina, macauba, carinata and corn. Some materials are partially biobased by combining fossil-based and biobased components into one material. Bio-naphtha and advanced fuels such as bio-diesel and sustainable aviation fuel represent bio-based feedstocks that can be utilized and converted into useful materials including surfactants, solvents and polymers. Bio-based content can be measured using the “Assessment of the Biobased Content of Materials” ASTM D6866-16 test method.

As used herein, the term “carbon capture and usage” refers to the process of capturing carbon from exhaust streams and/or waste streams to be recycled for further usage. Examples of carbon capture compounds include carbon dioxide, carbon monoxide, and methane. Captured carbon can be converted into different chemical forms including ethylene, synthesis gas, alcohols, alkanes, longer chain olefins, aromatic compounds, and other materials that can be converted into useful materials including surfactants, solvents and polymers.

As used herein, the term “chemically recycled” refers to the conversion of plastic and rubber, e.g. tires, waste streams back into feedstock for the chemical industry that can be used to manufacture products that have the same properties as those manufactured from fossil feedstock. Processes that can be used in chemical recycling include, but are not limited to, pyrolysis, thermocatalytic pyrolysis, cracking, hydrolysis and enzymatic degradation.

As used herein, the term “mechanically recycled” refers to the conversion of plastic waste streams back into material that can be used alone or in conjunction with virgin plastic sources to create new plastic-based products that have the same or similar properties as those manufactured entirely from virgin plastic feedstock sources.

As used herein, the term “waste converted” refers to the non-incineration conversion technologies and processes that are used to convert the non-recyclable portion of the municipal waste stream into electricity, fuels, and/or industrial chemical feedstocks. Examples of waste conversion technologies include, but are not limited to, gasification, plasma arc gasification, pyrolysis, hydrolysis/fermentation (waste-to-ethanol), anaerobic digestion, autoclave/mechanical processing, hydrotreatment, hydroprocessing, cracking, gasification and Fischer-Tropsch.

As used herein, the term “CMR (carcinogenic, mutagenic, reprotoxic) category 1A, 1B or 2” refers components of laundry composition which are defined in Annexes 1, 3.5, 3.6 and 3.7 of the European Commission regulation (EC) No. 1907/2006 and further described at https://reachonline.eu/clp/en/annex-i-3.html.

“Carcinogenic” means a substance or a mixture of substances which induce cancer or increase its incidence. Substances which have induced benign and malignant tumors in well performed experimental studies on animals are considered also to be presumed or suspected human carcinogens unless there is strong evidence that the mechanism of tumor formation is not relevant for humans.

“Mutagenic” means a substance or a mixture of substances giving rise to an increased occurrence of mutations in populations of cells and/or organisms. “Mutation” means a permanent change in the amount or structure of the genetic material in a cell and applies both to heritable genetic changes that may be manifested at the phenotypic level and to the underlying DNA modifications when known (including specific base pair changes and chromosomal translocations).

“Reprotoxic” means a substance or a mixture of substances giving rise to adverse effects on sexual function and fertility in adult males and females, as well as developmental toxicity in the offspring.

“Endocrine disruptor” means a substance or mixture of substances a chemical compound that interferes with the normal functioning of the endocrine system and the reproductive and other biological processes regulated by it. An “endocrine disruptor category 1” refers to a substance or substances where evidence of endocrine disrupting activity in at least one species using intact animals is present.

As used herein, the term “PBT” (Persistent Bioaccumulative & Toxic) refers to a substance or a mixture of substances that satisfy the criteria provided in sections 1.1.1.-1.1.3. as provided in https://reachonline.eu/reach/en/annex-xiii-1-1.1-1.1.1.html.

As used herein, the term “vPvB” (very Persistent very Bioaccumulative) refers to a substance or mixture of substances that satisfy the criteria provided in 1.2.1. and 1.2.2. as provided in https://reachonline.eu/reach/en/annex-xiii-1-1.2-1.2.1.html.

As used herein, the term “Potentially PMT (Persistent, Mobile and Toxic)/vPvM (very Persistent very Mobile)” refers to substances or mixtures thereof which accumulate in water, with consequent exposure to humans satisfying the “persistent” and “toxic” legs of the “PBT” substance(s) or the “very persistent” leg of the “vPvB” substance(s), respectively.

As used herein, the term “Respiratory and/or Skin Sensitizer” refers to a substance or mixture of substances that will lead to hypersensitivity of the airways following inhalation of the substance or a mixture thereof, or a substance or mixture of substances that will lead to an allergic response following skin contact.

As used herein, the term “STOT (Specific Target Organ Toxicity)” refers to non-lethal target organ toxicity arising from a single exposure to a substance or mixture of substances, or target organ toxicity arising from repeated exposure to a substance or mixture of substances.

As used herein, the term “Neuro and Immuno-Toxicant”, in the case of neuro-toxicant, refers to toxicants that produce a form of toxicity in which a biological, chemical or physical agent produces an adverse effect on the structure of function of the central and/or peripheral nervous system. In the case of immuno-toxicant, it is a toxicant that alter, negatively, both the innate and adaptive parts of the immune system. As used herein, the term “natural oils” means oils that are derived from plant or algae matter. Natural oils are not based on kerosene or other fossil fuels. The term “oils” include fats, fatty acids, waste fats, oils, or mixtures thereof. Natural oils include, but are not limited to, coconut oil, babassu oil, castor oil, algae byproduct, beef tallow oil, borage oil, camelina oil, Canola® oil, choice white grease, coffee oil, corn oil, Cuphea viscosissima oil, evening primrose oil, fish oil, hemp oil, hepar oil, jatropha oil, Lesquerella fendleri oil, linseed oil, Moringa oleifera oil, mustard oil, neem oil, palm (kernel) oil, perilla seed oil, poultry fat, rice bran oil, soybean oil, stillingia oil, sunflower oil, tung oil, yellow grease, cooking oil, and other vegetable, nut, or seed oils. A natural oil typically includes triglycerides, free fatty acids, or a combination of triglycerides and free fatty acids, and other trace compounds.

As used herein, the term “Geologically derived” means derived from, for example, petrochemicals, natural gas, or coal. “Geologically derived” materials cannot be easily replenished or regrown (e.g., in contrast to plant- or algae-produced materials).

The laundry detergent compositions and/or packaging of the present disclosure provide eco-friendly options for the consumer. Specifically, the laundry detergent compositions of the present disclosure may comprise renewable components, be biodegradable, have a low carbon footprint and exhibit good performance, such as cleaning, whiteness, color care, softness, shape retention and freshness. Laundry compositions comprise a variety of components which can impact the level of renewable carbon present, the biodegradability, as well as the carbon footprint. For example, some of the base building blocks for laundry compositions of the present disclosure include, but are not limited to: surfactants; polymers; solvents; chelants; enzymes; perfumes and aesthetic agents e.g. brighteners/hueing dyes; builders; bleaching systems and the like. Several of these components can play a part in the weight percentage of renewable carbon, the biodegradability of the laundry composition and/or the carbon footprint of the laundry composition. And certainly, each of these components plays a part in the performance of the laundry compositions described herein.

The laundry detergent compositions of the present disclosure may comprise from 10 to 100 percent by weight carbon-containing ingredients, wherein the carbon associated with those ingredients comprises from about 10 percent, or from about 20 percent or from about 30 percent, of from about 40 percent or from about 50 percent, to about 60 percent or to about 70 percent or to about 80 percent or to about 90 percent, or to about 100 percent by weight renewable carbon, specifically reciting all values within these range and any ranges created thereby. Renewable carbon is discussed in additional detail hereafter regarding the base building blocks.

The laundry detergent compositions disclosed herein may comprise from about 1 percent, or from about 5 percent, or from about 10 percent, or from about 20 percent, or from about 30 percent, of from about 40 percent or from about 50 percent, to about 60 percent or to about 70 percent or to about 80 percent or to about 90 percent, or to about 100 percent by weight of the individual ingredients pre-mixes or final formulations of biodegradable components, specifically reciting all values within these range and any ranges created thereby. Biodegradability can be assessed according to OECD readily biodegradable 301 test protocols, preferably the OECD 301B test protocol (OECD (1992), Test No. 301: Ready Biodegradability, OECD Guidelines for the Testing of Chemicals, Section 3, OECD Publishing, Paris, https://doi.org/10.1787/9789264070349-en.).

The laundry detergent compositions disclosed herein may comprise a carbon footprint expressed in CO₂ equivalent/kg of the individual components, pre-mixes or final formulations of less than 10 or less than 3 or less than 2 or less than 1.5 or less than 1 or less than 0.75 or less than 0.5 or less than 0.25 or zero or even a negative footprint, specifically reciting all values within these ranges and any ranges created thereby.

A myriad of ways exist in which the carbon footprint of the laundry compositions of the present disclosure may be reduced. One of the primary ways to reduce the carbon footprint of the laundry detergents of the present disclosure pertains to the energy used to make the laundry compositions. As an example, manufacturers of laundry compositions may utilize green energy, e.g. hydroelectricity, wind turbine generated electricity, solar generated electricity, natural gas driven turbines, nuclear generated electricity, or combinations thereof, in their mixing/converting processes. Additionally, for those components of the laundry composition for which external supply is required, the laundry composition manufacturer may require its one or more suppliers of these components to similarly subscribe to the above forms of energy generation for their respective manufacturing processes.

A second way to reduce the carbon footprint of the laundry compositions of the present disclosure pertains to the transportation of the laundry compositions or its components. As an example, laundry composition manufacturers may rely on electric vehicles, hydrogen fuel cell or natural gas-powered vehicles to transport from their manufacturing facilities to their customers. Laundry composition manufacturers may similarly require its one or more suppliers to ship their components to the laundry manufacturer's facilities via electric, hydrogen fuel cell or natural gas-powered vehicles.

Regarding transportation, the carbon footprint of the laundry compositions of the present disclosure may also be reduced by providing more efficient packaging. For example, the amount of air within the packages can be reduced which can allow for smaller packaging. This could allow for a higher number of products to be shipped per load which can lower the carbon footprint. As another example, the amount of water within the laundry composition may be reduced which can similarly allow for smaller packaging and drive more efficient shipping. Laundry composition manufacturers may require their one or more suppliers to similarly adhere to such shipping practices.

Additional mechanisms of reducing the carbon footprint for the laundry compositions of the present disclosure are achievable via compaction. The idea of compaction involves boosting the weight percentages of the actives in the laundry composition so that a smaller amount of laundry composition can be utilized per wash. For example, a laundry detergent may comprise 25 weight percent of actives and a user may be instructed to add 50 ml to their wash as an effective amount. However, if the active weight percent was boosted to 50%, then only 25 ml would be required as an effective amount of laundry composition. This boost in active weight percentage would allow for smaller packaging and more efficient shipping.

It is worth noting that such a boost in active weight percent may allow for additional reduction of the carbon footprint of the laundry compositions of the present disclosure. For example, the boost in active weight percent can be coupled with a reduction in the amount of solvent which is typically carbon based. In unit dose form the reduction of solvent may involve the reduction of alcohol, glycol or glycol ether-based solvents such as propanediol, glycerol, ethanol, polyethyleneglycol, or polypropyleneglycol. In liquid laundry compositions (not unit dose), the reduction of solvent may involve the removal of water, organic thickeners or structurants or organic solvent-based stabilizers.

Additionally, regarding transportation efficiencies, a higher volume of packages provided in transportation equals fewer trips made to ship the laundry composition from the manufacturer to its customers. Fewer trips equal less time that tires are on the road which in turn can lead to less carbon dioxide and/or carbon monoxide exhaust entering the atmosphere (lower carbon footprint) as well as a reduction in microplastics created by tire wear on roads.

In formulating the laundry compositions of the present disclosure, manufacturers may look at catalytic chemistry. Namely, manufacturers may look at active that can be formulated at low levels while delivering similar performance as traditional active formulated at higher levels. As one example, an enzyme may be utilized, at least in part, to replace or reduce the weight percentage of surfactant in the laundry composition which are typically carbon-based.

Additionally, manufacturers may increase the amount of recycled material with their packaging. Ideally, the packaging material would itself by recyclable as well. Alternate business models may also be utilized. For example, in store refill, e.g. laundry composition dispensing, may be utilized.

Still another method for reducing the carbon footprint of the laundry compositions of the present disclosure comprises waste reblend. Manufacturers of laundry compositions typically incorporate product specifications as part of their quality control of their manufacturing processes. Inevitably, there may be some portion of their product which does not meet their quality specifications. The manufacturer can opt to destroy, e.g. burn, or otherwise dispose of this out of spec. product, or the manufacturer can choose to incorporate the out of spec product back into the manufacturing stream in small amounts to ensure that it does not negatively impact the specifications of the product being produced. In this way, the components within the out of spec. product do not have to be reproduced or disposed of. In one particular example, in the unit dose form, the soluble packages may rupture during manufacturing. Rather than scrapping the out of spec. product, the composition within the unit dose product may be re-introduced into the manufacturing process.

Still another way to reduce the carbon footprint of laundry compositions is to focus on their end use. For example, the laundry detergents of the present disclosure may be specially formulated to allow for lower wash water temperature, a shorter wash cycles, and/or low water use wash cycles. With colder water temperatures, the kinetics of the laundry composition of the present disclosure need to be taken into account. Namely, in colder water the actives of the laundry composition have to act faster. Unfortunately, faster acting actives often equals lower performing actives. So, there is a balance. One particular area of focus for cold water laundry compositions regards the surfactants. Monomers having a high critical micelle concentration can act quickly as well as provide good performance. Also, surfactants that are surface active but still soluble may be of interest. One example of this type of surfactant is a branched surfactant. Still another component of the laundry compositions of the present disclosure which can enable colder water performance are enzymes. Enzymes specifically formulated for cold water performance are described hereafter.

Still another area of focus in creating eco-friendly laundry compositions is with regard to low water wash cycles. In order to be effective in such usage conditions, the laundry compositions should have improved dissolution and emulsification properties.

Yet another way to reduce the carbon footprint of the laundry compositions of the present disclosure is regarding the synthesis of the components therein. For example, some of the components of the laundry compositions of the present disclosure may be derived from carbon capture programs. In furtherance of this example, some components of the laundry compositions of the present disclosure, e.g. surfactants, polymers, can by synthesized from captured carbon. In one specific example, CO₂ emissions may be captured, converted into ethanol which can then be converted into ethylene oxide. The ethylene oxide may then be utilized in surfactant production.

In yet another example, one or more of the components within the laundry compositions of the present disclosure may be derived from bio-mass. In furtherance of this example, bio-mass may be cracked into materials to produce ethylene which can then be utilized to make surfactants. Additionally, paraffins from aviation fuels can be processed to make linear alkyl benzene sulphonate. An example of a bio-mass derived component, i.e. a chelating agent, is Trilon® M Max from BASF.

In yet another example, one or more of the components of the laundry compositions described herein may be derived from chemically recycled material. For example, polyethylene plastic may be depolymerized into ethylene. The ethylene can be further processed into a surfactant. Examples of chemically recycled components of laundry compositions are described in additional detail in U.S. Patent Application Publication Nos. 2012/0213726; 2014/0255330; 2022/0008304; 2014/0275468; 2015/0239798; 2018/0251411; 2017/0044465; 2019/0241838; and 2021/0108154.

In yet another example, the packaging of the laundry compositions of the present disclosure may be derived from mechanically recycled materials. For example, the packaging of the laundry compositions of the present disclosure may be derived from recycled plastic material, recycled cardboard or cartonboard material.

In yet another example, the laundry compositions, its packaging, the manufacture and/or transport of the same may utilize waste converted technology. For example, electricity used to run manufacturing equipment and/or electric vehicles may be derived from gas turbines utilizing methane sourced from waste landfills and/or sewage plants. As another example, household trash may be converted into fuel via gasification or pyrolysis.

The liquid laundry detergent compositions of the present disclosure may comprise between 1 percent and 20 percent, preferably between 1 percent and 15 percent by weight of the liquid laundry detergent composition of water, specifically reciting all values within these ranges and any ranges created thereby. Such liquid laundry detergent compositions are particularly suitable to be enclosed in a water-soluble film to create a unit dose article. Unit dose articles are discussed in additional detail hereafter.

Alternatively, the liquid laundry detergent compositions of the present disclosure may comprise greater than 20 percent of water, preferably between 25 percent and 60 percent by weight of the liquid laundry detergent composition of water, specifically reciting all values within these ranges and any ranges created thereby. Such liquid laundry detergent compositions are particularly suitable to be enclosed in a detergent bottle from which a portion can be poured for use in a washing operation.

Granular laundry detergent compositions might also comprise low levels of water, present as moisture adsorbed onto the detergent granules. Granular detergent compositions preferably comprise less than 5 percent by weight of the granular detergent composition of water.

### Surfactants

Preferably, the laundry detergent composition comprises a non-soap surfactant, wherein the non-soap surfactant preferably comprises anionic surfactant, non-ionic surfactant, cationic surfactant, amphoteric surfactant, zwitterionic surfactant, or a mixture thereof. The detergent composition may comprise between 10 percent and 60 percent, preferably between 12 percent and 55 percent, more preferably between 14 percent and 50 percent by weight of the laundry detergent composition of the non-soap surfactant, specifically reciting all values within these ranges and any ranges created thereby.

In some examples, the non-soap surfactant in the laundry detergent composition comprises a non-soap anionic surfactant. Without wishing to be bound by theory, it is believed that a formulation with a non-soap anionic surfactant is beneficial as such surfactants provide excellent all-round fabric cleaning, and especially excellent greasy stain removal.

The non-soap anionic surfactant may comprise linear alkylbenzene sulphonate. As an example, the linear alkylbenzene sulphonate comprises C₁₀-C₁₆ alkyl benzene sulfonate, C₁₁-C₁₄ alkyl benzene sulphonate or a mixture thereof. It may be preferable where the alkylbenzene sulphonate is an amine neutralized alkylbenzene sulphonate, an alkali metal neutralized alkylbenzene sulphonate, or a mixture thereof. The amine may be selected from monoethanolamine, triethanolamine, or mixtures thereof, preferably monoethanolamine. The alkali metal may be selected from sodium, potassium, magnesium or a mixture thereof, preferably sodium.

The laundry detergent composition of the present disclosure may comprise between about 1 percent and about 35 percent, preferably between about 5 percent and about 30 percent, or more preferably between about 10 percent and about 25 percent by weight of the laundry detergent composition of the linear alkylbenzene sulphonate anionic surfactant, specifically reciting all values within these ranges and any ranges created thereby. Without wishing to be bound by theory it is believed that linear alkylbenzene sulphonate anionic surfactants provide the benefit of greasy stain removal and general overall fabric cleaning.

The non-soap anionic surfactant may comprise an alkyl sulphate anionic surfactant wherein the alkyl sulphate anionic surfactant is selected from alkyl sulphate, an alkoxylated alkyl sulphate, or a mixture thereof. The alkyl sulphate anionic surfactant may be a primary or a secondary alkyl sulphate anionic surfactant, or a mixture thereof. A primary alkyl sulphate anionic surfactant may be preferable. The alkoxylated alkyl sulphate may comprise ethoxylated alkyl sulphate, propoxylated alkyl sulphate, a mixed ethoxylated/propoxylated alkyl sulphate, or a mixture thereof. An ethoxylated alkyl sulphate may be preferred. The ethoxylated alkyl sulphate can have an average degree of ethoxylation of between 0.1 to 5 or preferably between 0.5 and 3, specifically reciting all values within these range and any ranges created thereby. The ethoxylated alkyl sulphate can have an average alkyl chain length of between 8 and 18, more preferably between 10 and 16, or most preferably between 12 and 15, specifically reciting all values within these ranges and any range created thereby. The alkyl chain of the alkyl sulphate anionic surfactant can be linear, branched or a mixture thereof. The branched alkyl sulphate anionic surfactant can be a branched primary alkyl sulphate, a branched secondary alkyl sulphate, or a mixture thereof. It may be preferable the branched alkyl sulphate anionic surfactant to be a branched primary alkyl sulphate, wherein the branching preferably is in the 2-position, or alternatively might be present further down the alkyl chain or could be multi-branched with branches spread over the alkyl chain. The weight average degree of branching of alkyl sulphate anionic surfactant may be from about 0 percent to about 100 percent, preferably from about 0 percent to about 95 percent, more preferably from about 0 percent to about 60 percent, or most preferably from about 0 percent to about 20 percent, specifically reciting all values within these ranges and any ranges created thereby. Alternatively, the weight average degree of branching of alkyl sulphate anionic surfactant may be from about 70 percent to about 100 percent, preferably from about 80 percent to about 90 percent, specifically reciting all values within these ranges and any ranges created thereby.

The alkyl chain may be selected from naturally derived material, synthetically derived material, or mixtures thereof. The synthetically derived material may comprise oxo-synthesized material, Ziegler-synthesized material, Guerbet-synthesized material, Fischer-Tropsch—synthesized material, iso-alkyl synthesized material, or mixtures thereof. It may be preferable for the alkyl chain to comprise oxo-synthesized material.

From a renewable carbon standpoint, the alkyl chain may be derived from vegetable oil, coconut oil and palm kernel oil. It is worth noting that the alkyl chain may be chemically bound to a hydrophilic head group. The hydrophilic head group may or may not be derived from a renewable carbon resource. Some exemplary surfactants comprising a hydrophilic head group are alkyl polysaccharides, e.g. alkyl polyglycosides. In such examples, the polyglycoside headgroup may be derived from sugars with polyglucosides being the most dominant class there derived from glucose.

Still in other forms, the surfactants may be naturally derived. For example, surfactants may be derived from bacteria, e.g. rhamnolipids. As another example, surfactants may be derived from yeasts, e.g. sophorolipids. In yet another example, surfactants may be derived from algae e.g. betaine surfactants.

It may be preferable where the alkyl sulphate anionic surfactant is an amine neutralized alkyl sulphate anionic surfactant, an alkali metal neutralized alkyl sulphate anionic surfactant, or a mixture thereof. The amine may be selected from monoethanolamine, triethanolamine, or mixtures thereof, preferably monoethanolamine. The alkali metal may be selected from sodium, potassium, magnesium or a mixture thereof, preferably sodium.

The laundry detergent composition of the present disclosure may comprise between about 1 percent and about 35 percent, preferably between about 5 percent and about 30 percent, or more preferably between about 10 percent and about 25 percent by weight of the laundry detergent composition of the alkyl sulphate anionic surfactant, specifically reciting all values within these ranges and any ranges created thereby. Without wishing to be bound by theory it is believed that alkyl sulphate anionic surfactants provide the benefit of grass stain removal, blood stain removal, soil suspension and overall body soil cleaning.

The non-soap anionic surfactant may comprise a linear alkyl benzene sulphonate and an alkoxylated alkyl sulphate and wherein the weight ratio of linear alkylbenzene sulphonate to alkoxylated alkyl sulphate is from about 1:2 to 9:1, preferably from about 1:1 to 7:1, more preferably from 1:1 to 5:1, or most preferably from 1:1 to 4:1, specifically reciting all values within these ranges and any ranges created thereby. Without wishing to be bound by theory, it is believed that formulating these anionic surfactants in the ratios provided enhances the benefit of providing excellent stain removal and cleaning across a broad range of stains.

The non-soap surfactant may comprise a non-ionic surfactant, wherein the non-ionic surfactant comprises an alkoxylated alcohol, wherein the alkoxylated alcohol is derived from a synthetical alcohol, a natural alcohol or a mixture thereof. The alkoxylated alcohol can be a primary alkoxylated alcohol, a secondary alkoxylated alcohol, or a mixture thereof. It may be preferable for it to be a primary alkoxylated alcohol. The alkoxylated alcohol may comprise ethoxylated alcohol, propoxylated alcohol, a mixed ethoxylated/propoxylated alcohol, or a mixture thereof. It may be preferable for alkoxylated alcohol to be an ethoxylated alcohol.

Alternatively, the alkoxylated alcohol might also include higher alkoxy groups such as butoxy groups. When mixed alkoxy groups, the alkoxy groups can be randomly ordered or present in blocks. It may be preferably for the alkoxy groups to be present in blocks. For example, mixed ethoxy (EO)/propoxy (PO) groups might be ordered in EO/PO blocks, PO/EO blocks, EO/PO/EO blocks or PO/EO/PO blocks. The ethoxylated alcohol can have an average degree of ethoxylation of between 0.1 to 20, preferably between 5 and 15, most preferably between 6 and 10, specifically reciting all values within these ranges and any ranges created thereby. If propoxylation is present, preferably the average degree of propoxylation is between 0.1 to 25, more preferably between 2 and 20, most preferably between 5 and 10, specifically reciting all values within these ranges and any ranges created thereby. The alkoxylated, preferably ethoxylated, alcohol can have an average alkyl chain length of between 8 and 18, more preferably between 10 and 16, most preferably between 12 and 15, specifically reciting all values within these ranges and any ranges created thereby. The alkyl chain of the alkoxylated alcohol can be linear, branched or a mixture thereof, wherein the branched alkoxylated alcohol is a branched primary alkoxylated alcohol, a branched secondary alkoxylated alcohol, or a mixture thereof. A branched primary alkoxylated alcohol may be preferable.

The weight average degree of branching of the alkoxylated alcohol can be from about 0 percent to about 100 percent, preferably from about 0 percent to about 95 percent, more preferably about 0 percent to about 60 percent, most preferably from about 0 percent to about 20 percent. The branching can be on the 2-alkyl position, or alternatively further down the alkyl chain, or can be multi-branched with individual branches spread over the alkyl chain. The synthetically derived material may comprise oxo-synthesized material, Ziegler-synthesized material, Guerbet-synthesized material, Fischer-Tropsch—synthesized material, iso-alkyl branched materials, or mixtures thereof. It may be preferable where the synthetically derived material comprises oxo-synthesized material.

It is worth noting however, that if the desired outcome is to utilize renewable carbon content in the laundry composition, then alkoxylated alcohols based on naturally derived alkyl chains are preferable. For example, the naturally derived alkyl chains may be obtained from coconut or palm kernel oil are preferable. The laundry detergent composition may comprise between about 0.5 percent and about 20 percent, preferably between about 1 percent and about 15 percent, more preferably between about 2 percent and about 12 percent by weight of the laundry detergent composition of the non-ionic surfactant, specifically reciting all values within these ranges and any ranges created thereby. It may be preferable for the nonionic surfactant to consist of the alkoxylated alcohol. Without wishing to be bound by theory, it is believed that non-ionic surfactants, especially alkoxylated alcohol non-ionic surfactants, provide the benefit of excellent body soil cleaning and soil suspension.

The weight ratio of non-soap anionic surfactant to nonionic surfactant is from 1:1 to 20:1, from 1.5:1 to 17.5:1, from 2:1 to 15:1, or from 2.5:1 to 13:1, specifically reciting all values within these ranges and any ranges created thereby.

The laundry detergent composition may comprise a surfactant system wherein the surfactant system further comprises a cationic surfactant. Preferably the cationic surfactant is present between 0.1 percent and 10 percent, more preferably between 0.5 percent and 5 percent, by weight of the laundry detergent composition. Suitable cationic detersive surfactants include alkyl pyridinium compounds, alkyl quaternary ammonium compounds, alkyl quaternary phosphonium compounds, alkyl ternary sulphonium compounds, and mixtures thereof. Preferred cationic detersive surfactants are quaternary ammonium compounds having the general formula:

(R)(R₁)(R₂)(R₃)N⁺X⁻
wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

The laundry detergent may comprise a surfactant system wherein the surfactant system further comprises an amphoteric surfactant, a zwitterionic surfactant, or a mixture thereof, preferably wherein the amphoteric surfactant is an amine oxide surfactant and wherein the zwitterionic surfactant is a betaine surfactant. Preferably, the amine oxide surfactant is selected from the group consisting of: alkyl dimethyl amine oxide, alkyl amido propyl dimethyl amine oxide, and mixtures thereof, most preferably C12-C14 alkyl dimethyl amine oxide, especially wherein the C12-14 chain is natural derived, preferably coconut oil derived. Suitable zwitterionic surfactants include betaine surfactants, preferably cocamidopropyl betaine. More preferably the additional amphoteric and/or zwitterionic surfactant is present between 0.1 percent and 10 percent, more preferably between 0.5 percent and 5 percent by weight of the laundry detergent composition.

The laundry detergent composition may comprise a fatty acid, e.g. a neutralized fatty acid soap. It may be preferable where the laundry detergent composition comprises between about 1 percent and about 15 percent by weight of the liquid detergent composition of fatty acid. The fatty acid may be branched or linear, alkoxylated or non-alkoxylated, preferably non-alkoxylated. When alkoxylated the fatty acid preferably is ethoxylated. The fatty acid may be selected from palm kernel fatty acid, coconut fatty acid, rapeseed fatty acid, neutralized palm kernel fatty acid, neutralized coconut fatty acid, neutralized rapeseed fatty acid, or a mixture thereof, most preferably a neutralized palm kernel fatty acid. The fatty acid soap may be neutralised with an alkali metal, an amine, or a mixture thereof. The amine may be selected from monoethanolamine, diethanolamine, monoisopropanolamine, triethanolamine, ammonia, or mixtures thereof and the alkali metal is selected from sodium, potassium, magnesium, or a mixture thereof. Without wishing to be bound by theory, it is believed that the fatty acid, e.g. neutralized fatty acids, provide the benefit of protecting anionic non-soap surfactant from precipitation. Furthermore, they provide the benefit of clay soil removal and body soil cleaning on fabrics.

Regarding the biodegradability of surfactants, manufacturers of laundry compositions can have much control in this area. For example, manufacturers may require that the laundry compositions and/or packaging pass the OECD 301B Biodegredation Test. From a chemistry standpoint, it is worth noting that linear hydrophobes are readily biodegradable and only some branched hydrophobes are. Quarternary carbons do not degrade. Also, stacked branching on adjacent carbon atoms in an alkyl chain can decrease biodegradability. And, propylene oxide and butylene oxide alkoxylates do not degrade as well as ethylene oxide.

### Polymers

The laundry detergent composition may comprise an amphiphilic graft polymer. The amphiphilic graft polymer can be based on polyalkylene oxides and vinyl esters. It may be preferable where the amphiphilic graft polymer is based on water-soluble polyalkylene oxides (A) as a graft base and side chains formed by polymerization of a vinyl ester component (B), said polymer having an average of <1 graft site per 50 alkylene oxide units. The molar ratio of grafted to ungrafted alkylene oxide units can be from about 0.002 to about 0.05, preferably from about 0.002 to about 0.035, more preferably from about 0.003 to about 0.025, or most preferably from about 0.004 to about 0.02, specifically reciting all values within these ranges and any ranges created thereby.

The amphiphilic graft polymer can have from about 20 percent to about 70 percent, preferably from about 25 percent to about 60 percent by weight of the amphiphilic graft polymer of the polyalkylene oxide (A), e.g. the water-soluble polyalkylene oxide (A) as a graft base. The amphiphilic graft polymer may comprise from about 30 percent to about 80 percent by weight of the vinyl ester component (B), e.g. wherein the vinyl ester component (B) comprises a vinyl acetate, vinyl propionate or a mixture thereof (B1), and optionally an C1-C8-alkyl acrylate (B2) more preferably from about 70 percent to about 100 percent by weight of vinyl acetate (B1) and from about 0 percent to about 30 percent by weight of a C1-C8-alkyl acrylate (B2). Preferably, the amphiphilic graft polymer comprises a polyalkylene oxide graft base (A) where the polyalkylene oxide graft base (A) is a polyethylene glycol. The amphiphilic graft polymer may comprise less than about 10 percent by weight of the amphiphilic graft polymer of polyvinyl ester (B) in ungrafted form. It may be preferable where the amphiphilic graft polymer can have a mean molecular mass Mw of from 3000 to 100000. It may be preferable where the amphiphilic graft polymer has a polydispersity Mw/Mn of less than 3, wherein Mn is the mean molar mass. The laundry detergent composition may comprise between about 0.1 percent and about 10 percent, preferably between about 0.5 percent and about 5 percent, even more preferably between about 0.75 percent and about 4 percent, or most preferably between about 1 percent and about 3 percent by weight of the laundry detergent composition of the amphiphilic graft polymer. Without wishing to be bound by theory, it is believed that amphiphilic graft polymers provide the benefit of boosting surfactant performance and soil suspension during the wash process.

The laundry detergent composition may comprise an ethoxylated polyethyleneimine. The ethoxylated polyethyleneimine can have a polyethyleneimine backbone having a weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, specifically reciting all values within these ranges and any ranges created thereby. The ethoxylated polyethyleneimine has an average of 5 to 40, preferably 10 to 30, more preferably 15 to 25 or most preferably 18 to 22 ethoxy units per ethoxylation chain, specifically reciting all values within these ranges and any ranges created thereby. Preferably, the ethoxylated polyethyleneimine has a total weight average molecular weight of from about 5000 g/mol to about 20000 g/mol, preferably from about 7500 g/mol to about 17500 g/mol, more preferably from about 10000 g/mol to about 15000 g/mol, most preferably from about 12000 g/mol to about 13000 g/mol, specifically reciting all values within these ranges and any ranges created thereby.

Preferably, the terminal ethoxy moiety of the ethoxylation modification of the ethoxylated polyethyleneimine is capped with hydrogen, a C₄-C₄ alkyl, or mixtures thereof, preferably hydrogen. Preferably, the degree of permanent quaternization of the ethoxylated polyethyleneimine is from about 0 percent to about 30 percent of the polyethyleneimine backbone nitrogen atoms, preferably 0 percent. The laundry detergent composition may comprise between 0.5 percent and 10 percent, preferably between 1 percent and 7.5 percent, more preferably between 2 percent and 6 percent, most preferably between 3 percent and 5 percent by weight of the laundry detergent composition of the ethoxylated polyethyleneimine, specifically reciting all values within these ranges and any ranges created thereby. Without wishing to be bound by theory, ethoxylated polyethyleneimines provide the benefit of soil suspension and clay stain removal in the wash and fabric whiteness benefits.

The laundry detergent composition may comprise an amphiphilic alkoxylated polyalkyleneimine. Preferably, the amphiphilic alkoxylated polyalkyleneimine is an alkoxylated polyethyleneimine polymer comprising a polyethyleneimine backbone having a weight average molecular weight range of from 100 to 5,000, preferably from 400 to 2,000, more preferably from 400 to 1,000 Daltons, specifically reciting all values within these ranges and any ranges created thereby. The polyethyleneimine backbone comprises the following modifications:
(i) one or two alkoxylation modifications per nitrogen atom, dependent on whether the modification occurs at an internal nitrogen atom or at an terminal nitrogen atom, in the polyethyleneimine backbone, the alkoxylation modification consisting of the replacement of a hydrogen atom on by a polyalkoxylene chain having an average of about 1 to about 50 alkoxy moieties per modification, wherein the terminal alkoxy moiety of the alkoxylation modification is capped with hydrogen, a C1-C4 alkyl, or mixtures thereof;
(ii) a substitution of one C1-C4 alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C1-C4 alkyl, or mixtures thereof; or
(iii) a combination thereof.

For example, but not limited to, below is shown possible modifications to terminal nitrogen atoms in the polyethyleneimine backbone where R represents an ethylene spacer and E represents a C1-C4 alkyl moiety and X— represents a suitable water soluble counterion:

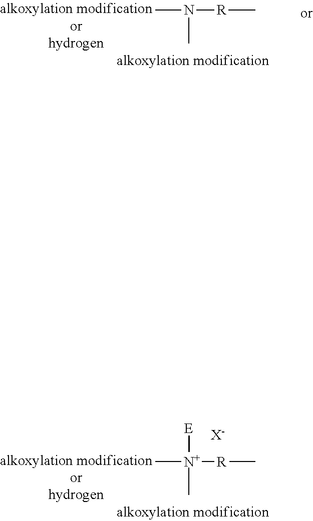

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion:

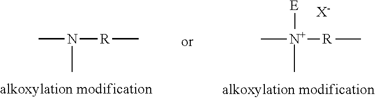

The alkoxylation modification of the polyethyleneimine backbone consists of the replacement of a hydrogen atom by a polyalkoxylene chain having an average of about 1 to about 50 alkoxy moieties, preferably from about 20 to about 45 alkoxy moieties, most preferably from about 30 to about 45 alkoxy moieties, specifically reciting all values within these ranges and any ranges created thereby. The alkoxy moieties are selected from ethoxy (EO), propoxy (PO), butoxy (BO), and mixtures thereof. Alkoxy moieties solely comprising ethoxy units are outside the scope of use for the invention though. Preferably, the polyalkoxylene chain is selected from ethoxy/propoxy block moieties. More preferably, the polyalkoxylene chain is ethoxy/propoxy block moieties having an average degree of ethoxylation from about 3 to about 30 and an average degree of propoxylation from about 1 to about 20, more preferably ethoxy/propoxy block moieties having an average degree of ethoxylation from about 20 to about 30 and an average degree of propoxylation from about 10 to about 20. More preferably the ethoxy/propoxy block moieties have a relative ethoxy to propoxy unit ratio between 3 to 1 and 1 to 1, preferably between 2 to 1 and 1 to 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0 percent to about 30 percent of the polyethyleneimine backbone nitrogen atoms. It is preferred to have less than 30 percent of the polyethyleneimine backbone nitrogen atoms permanently quaternized. Most preferably the degree of quaternization is about 0 percent, specifically reciting all values within these ranges and any ranges created thereby.

A preferred amphiphilic alkoxylated polyethyleneimine polymer has the general structure of formula (II):

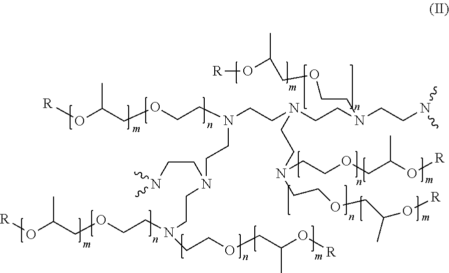

wherein the polyethyleneimine backbone has a weight average molecular weight of about 600, n of formula (II) has an average of about 10, m of formula (II) has an average of about 7 and R of formula (II) is selected from hydrogen, a C₁-C₄ alkyl and mixtures thereof, preferably hydrogen. The degree of permanent quaternization of formula (II) may be from 0 percent to about 22 percent of the polyethyleneimine backbone nitrogen atoms. The molecular weight of this amphiphilic alkoxylated polyethyleneimine polymer preferably is between 10,000 Da and 15,000 Da.

More preferably, the amphiphilic alkoxylated polyethyleneimine polymer has the general structure of formula (II) but wherein the polyethyleneimine backbone has a weight average molecular weight of about 600 Da, n of Formula (II) has an average of about 24, m of Formula (II) has an average of about 16 and R of Formula (II) is selected from hydrogen, a C₁-C₄ alkyl and mixtures thereof, preferably hydrogen. The degree of permanent quaternization of Formula (II) may be from 0 percent to about 22 percent of the polyethyleneimine backbone nitrogen atoms and is preferably 0 percent. The molecular weight of this amphiphilic alkoxylated polyethyleneimine polymer preferably is between 25,000 and 30,000, most preferably 28,000 Da.

Preferably, the laundry detergent composition comprises between 0.5 percent and 10 percent, preferably between 1 percent and 7.5 percent, more preferably between 2 percent and 6 percent, most preferably between 3 percent and 5 percent by weight of the laundry detergent composition of the amphiphilic alkoxylated polyalkyleneimine, specifically reciting all values within these ranges and any ranges created thereby.

The amphiphilic alkoxylated polyethyleneimine polymers can be made by the methods described in more detail in PCT Publication No. WO 2007/135645.

Without wishing to be bound by theory, amphiphilic alkoxylated polyalkyleneimine provide the benefit of grease removal and emulsification, and general body soil removal in the wash and fabric whiteness benefits.

Preferably, the laundry detergent composition of the present disclosure comprises an ethyleneoxide (EO)—propyleneoxide (PO)—ethyleneoxide (EO) triblock co-polymer of Formula:

(EO)x-(PO)y-(EO)x
wherein, each x is independently on average between 1 and 80, preferably between 3 and 60, more preferably between 5 and 50, most preferably between 5 and 30; and y is on average between 1 and 60, preferably between 10 and 55, more preferably between 10 and 50, more preferably between 15 and 48. Preferably, the triblock co-polymer has an average molecular weight of between 140 and 10500, preferably between 800 and 8500, more preferably between 1000 and 7300, even more preferably between 1300 and 5500, most preferably between 2000 and 4800. Preferably, the triblock co-polymer has a ratio of y to each x of from 1:1 to 3:1, preferably from 1.5:1 to 2.5:1. Preferably, the triblock co-polymer has an average weight percentage of total EO of between 30 percent and 50 percent by weight of the tri-block co-polymer. Preferably, the laundry detergent composition comprises between 0.1 percent and 10 percent, preferably between 0.5 percent and 7.5 percent, more preferably between 1 percent and 5 percent, by weight of the laundry detergent composition of the tri-block co-polymer. Without wishing to be bound by theory, such triblock copolymers provide the benefit of soil suspension.

The laundry detergent composition may comprise a zwitterionic polyamine. The zwitterionic polyamine is selected from zwitterionic polyamines according to the following formula:

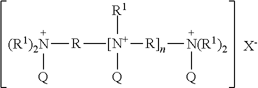

wherein, R is C3-C20, preferably C5-C10, more preferably C6-C8 linear or branched alkylene, and mixtures thereof, most preferably linear C6; R¹ is an anionic unit-capped polyalkyleneoxy unit having the formula: —(R2O)xR3, wherein R2 is C2-C4 linear or branched alkylene, and mixtures thereof, preferably C2 or branched C3, and mixtures thereof, more preferably C2 (ethylene); R3 is hydrogen, an anionic unit, and mixtures thereof, in which not all R3 groups are hydrogen, preferably wherein R3 anionic units are selected from —(CH2)pCO2M; —(CH2)qSO3M; —(CH2)qOS03M; —(CH2)qCH(SO2M)-CH2SO3M; —(CH2)qCH(OS02M)CH2OSO3M; —(CH2)qCH(SO3M)CH2SO3M; —(CH2)pP03M; —P03M; —SO3M, and mixtures thereof; wherein p and q are integers from 0 to 6, preferably 0 to 2, most preferably 0; wherein M is hydrogen or a water soluble cation, preferably selected from sodium, potassium, ammonium, and mixtures thereof and in sufficient amount to satisfy charge balance; wherein x is from 5 to 50, preferably from 10 to 40, even more preferably from 15 to 30, most preferably from 20 to 25; wherein Q is a quaternizing unit selected from the group consisting of C1-C30 linear or branched alkyl, C6-C30 cycloalkyl, C7-C30 substituted or unsubstituted alkylenearyl, and mixtures thereof, preferably C1-C30 linear or branched alkyl, even more preferably C1-C10 or even C1-C5 linear or branched alkyl, most preferably methyl, where the degree of quaternization of the zwitterionic polyamine is preferably more than 50 percent, more preferably more than 70 percent, even more preferably more than 90 percent, most preferably about 100; wherein X is an anion present in sufficient amount to provide electronic neutrality, preferably a water soluble anion selected from the group consisting of chlorine, bromine, iodine, methylsulfate, and mixtures thereof, more preferably chloride; n is from 0 to 4, preferably 0 to 2, most preferably 0.

Preferably said zwitterionic polyamine is selected from zwitterionic polyamines according to the following formula:

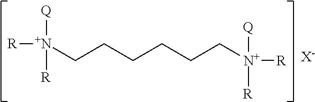

wherein, R is an anionic unit-capped polyalkyleneoxy unit having the formula: —(R2O)ₓR3; wherein R2 is C2-C4 linear or branched alkylene, and mixtures thereof, preferably C2 or branched C3, and mixtures thereof, even more preferably C2 (ethylene); R3 is hydrogen, an anionic unit, and mixtures thereof, in which not all R3 groups are hydrogen, preferably wherein R3 anionic units include —(CH2)pCO2M; —(CH2)qSO3M; —(CH2)qOS03M; —(CH2)qCH(SO2M)-CH2SO3M; —(CH2)qCH(OS02M)CH2OSO3M; —(CH2)qCH(SO3M)CH2SO3M; —(CH2)pP03M; —P03M; —SO3M; and mixtures thereof, wherein p and q are integers from 0 to 6, preferably 0 to 2, most preferably 0; and wherein M is hydrogen or a water soluble cation in sufficient amount to satisfy charge balance, preferably selected from sodium, potassium, ammonium, and mixtures thereof and in sufficient amount to satisfy charge balance; x is from 5 to 50, preferably from 10 to 40, even more preferably from 15 to 30, most preferably from 20 to 25; Q is a quaternizing unit selected from the group consisting of C1-C30 linear or branched alkyl, C6-C30 cycloalkyl, C7-C30 substituted or unsubstituted alkylenearyl, and mixtures thereof, preferably C1-C30 linear or branched alkyl, even more preferably C1-C10 or even C1-C5 linear or branched alkyl, most preferably methyl; the degree of quaternization of the zwitterionic polyamine preferably is more than 50 percent, more preferably more than 70 percent, even more preferably more than 90 percent, most preferably about 100 percent; X is an anion present in sufficient amount to provide electronic neutrality, preferably a water soluble anion selected from the group consisting of chlorine, bromine, iodine, methylsulfate, and mixtures thereof, more preferably chloride; wherein preferably from about 10 percent to about 100 percent, more preferably from about 20 percent to about 70 percent, even more preferably from 30 percent to about 50 percent, most preferably from about 35 percent to about 45 percent of the R3 groups are an anionic unit, preferably a —SO3M, the remaining R3 units being hydrogen.

More preferably, said zwitterionic polyamine is selected from zwitterionic polyamines according to the following formula:

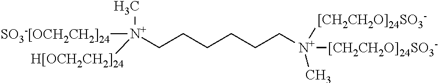

wherein from about 20 percent to about 70 percent, preferably from 30 percent to about 50 percent, more preferably from about 35 percent to about 45 percent, most preferably about 40 percent of the polyethoxy groups are sulfonated, the remaining polyethoxy groups being hydrogen capped. The degree of quaternization of the zwitterionic polyamine preferably is more than 90 percent, most preferably about 100 percent, and preferably the water-soluble counter-anion is selected from the group consisting of chlorine, bromine, iodine, methylsulfate, and mixtures thereof, more preferably chloride.

Preferably, the laundry detergent composition comprises between 0.01 percent to about 20 percent, preferably from 0.1 percent to 10 percent, more preferably from 0.5 percent to 7 percent, even more preferably from 1 percent to 5 percent, most preferably from 2 percent to 4 percent by weight of the laundry detergent composition of the zwitterionic polyamine, specifically reciting all values within these ranges and any ranges created thereby.

Without wishing to be bound by theory it is believed that zwitterionic polyamines provide the benefit of acting as a co-surfactant to boost the activity of other surfactants present.

Preferably, the laundry detergent composition comprises a polyester terephthalate soil release polymer. Preferably, the polyester terephthalate is a polyester terephthalate backbone grafted with one or more anionic groups. Preferably, the polyester terephthalate comprises the structural units (I) to (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are (C₁-C₂₂) alkyl or (C₂-C₁₀) hydroxyalkyl, or mixtures thereof;
R¹, R², R³, R⁴, R⁵ and R⁶ are independently selected from H or (C₁-C₁₈) n- or iso-alkyl preferably methyl; and R⁷ is a linear or branched (C₁-C₁₈) alkyl, or a linear or branched (C₂-C₃₀) alkenyl, or a cycloalkyl group with 5 to 9 carbon atoms, a (C₆-C₃₀) aryl group or a (C₆-C₅₀) arylalkyl group preferably phenyl or benzyl.

Preferably, the anionic polyester comprises the structural units (I) to (III), wherein R¹to R⁶ independently are H or methyl; R⁷ is methyl; a, b and c are a number from 1 to 20, preferably a and b are 1 and c is a number from 2 to 10; d is a number between 1 and 25, preferably between 1 and 10, more preferably between 1 and 5; e is a number between 1 and 30, preferably between 2 and 15, more preferably between 3 and 10; and f is a number between 0.05 and 15, preferably between 0.1 and 10, more preferably between 0.25 and 3. Preferably, the polyester terephthalate is an anionic polyester of propylene terephthalate.

Preferably the polyester terephthalate further comprises a polyester terephthalate backbone not comprising any charged grafting groups. The uncharged polyester terephthalate comprises the structural units (I) to (II):

—[(OCHR1-CHR2)a-O—OC—Ar—CO-]c (I)

—[(OCHR3-CHR4)b-OR5]d (II)
wherein:
a and b are from 1 to 200;
c and d are from 1 to 50;
Ar is a 1,4-substituted phenylene;
R1, R2, R3 and R4 are independently selected from H or (C1-C18) n- or iso-alkyl preferably methyl; and R5 is a linear or branched (C1-C18) alkyl, or a linear or branched (C2-C30) alkenyl, or a cycloalkyl group with 5 to 9 carbon atoms, a (C6-C30) aryl group or a (C6-C50) arylalkyl group preferably phenyl or benzyl. Preferably, the uncharged polyester terephthalate is an uncharged polyester of propylene terephthalate.

Most preferably the polyester terephthalate comprises a mixture of an anionically grafted polyester terephthalate and a nonionic polyester terephthalate as described above, preferably wherein the anionic polyester terephthalate and the nonionic polyester terephthalate are in a weight ratio of from 10:1 to 1:10, more preferably of from 7:1 to 1:5, even more preferably of from 5:1 to 1:1, specifically reciting all values within these ranges and any ranges created thereby.

Preferably, the laundry detergent composition comprises between 0.1 percent and 10 percent, preferably between 0.15 percent and 5 percent even more preferably between 0.2 percent and 4 percent, most preferably between 0.25 percent and 3 percent by weight of the laundry detergent composition of the polyester terephthalate, specifically reciting all values within these ranges and any ranges created thereby. Without wishing to be bound by theory, polyester terephthalates provide the benefit of soil release on fabrics.

Preferably, the laundry detergent composition comprises a cationic polymer, preferably wherein the cationic polymer is a cationic polysaccharide more preferably wherein the cationic polysaccharide is selected from the list consisting of cationic celluloses, cationic guar gums, cationic starches, cationically modified poly alpha-1,6-glucan ether compounds, or a mixture thereof, wherein these cationic polymers preferably comprise a respective guar, starch or glucan backbone derivatized with trimethyl ammonium substituted epoxide, and wherein these cationic polymers optionally further comprise hydrophobic modification.

Preferably, the cationic polysaccharide is a cationic cellulose having the structure:

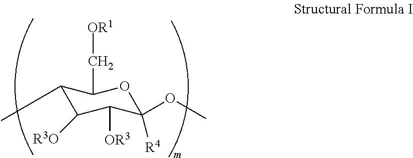

wherein:
a. m is an integer from 20 to 10,000
b. each R4 is H, and
c. R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

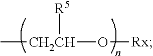

wherein:
n is an integer selected from 0 to 10 and
Rx is selected from the group consisting of: R₅;

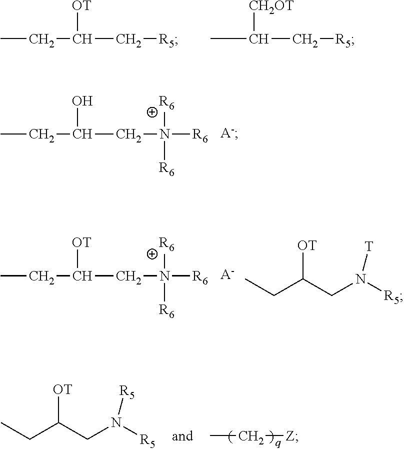

wherein at least one Rx in said polysaccharide has a structure selected from the group consisting of:

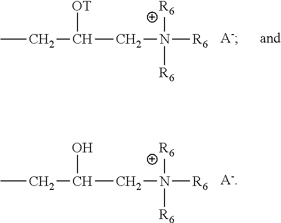

wherein A⁻ is a suitable anion.
q is an integer selected from 1 to 4;
each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH;
each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl;
each T is independently selected from the group: H,

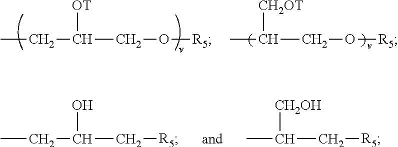

wherein each v in said polysaccharide is an integer from 1 to 10; the sum of all v indices in each Rx in said polysaccharide is an integer from 1 to 30; and in the last

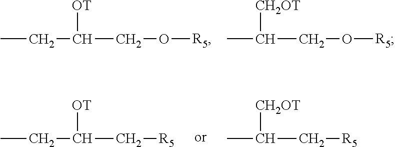

group in a chain, T is always an H.

Preferably, the cationic polysaccharide is a cationic hydroxyethyl cellulose polymer, preferably a hydroxyethylcellulose polymer derivatised with trimethyl ammonium substituted epoxide. Optionally the cationic polysaccharide has been hydrophobically modified through substitution of hydrophobic groups.

Alternative cationic polysaccharides include cationic guar gums, cationic starches, cationically modified poly alpha-1,6-glucan ether compounds, or mixtures thereof. These polymers comprise a respective guar, starch or glucan backbone derivatized with trimethyl ammonium substituted epoxide. Optionally these alternative cationic polysaccharide groups equally comprise hydrophobic modification.

Preferably, the laundry detergent composition comprises from 0.01 percent to 20 percent, preferably from 0.1 percent to 15 percent, more preferably from 0.6 percent to 10 percent by weight of the laundry detergent composition of the cationic polysaccharide, specifically reciting all values within these ranges and any ranges created thereby.

Without wishing to be bound by theory, cationic polysaccharides provide the benefit of care to fabrics and can also act as a deposition aid for other formulation ingredients onto fabrics.

Preferably, the laundry detergent composition comprises a carboxylate polymer. The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt percent structural units derived from one or more monomers comprising carboxyl groups; (ii) from 1 to less than 49 wt percent structural units derived from one or more monomers comprising sulfonate moieties; and (iii) from 1 to 49 wt percent structural units derived from one or more types of monomers selected from ether bond-containing monomers represented by formulas (I) and (II):

formula (I):

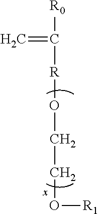

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; formula (II)

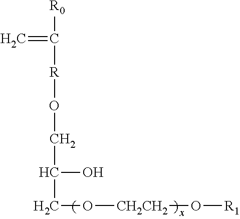

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group. It may be preferred that the polymer has a weight average molecular weight of at least 50 kDa, or even at least 70 kDa.

Preferably the laundry detergent composition comprises the carboxylate polymer at a level between 0.1 percent and 10 percent, preferably between 0.15 percent and 5 percent even more preferably between 0.2 percent and 4 percent, most preferably between 0.25 percent and 3 percent by weight of the laundry detergent composition, specifically reciting all values within these ranges and any ranges created thereby.

Preferably the laundry detergent composition comprises an anionically modified cellulosic polymer, more preferably wherein the anionically modified cellulosic polymer is a carboxymethyl cellulose. The anionically-modified cellulosic polymer is used to prevent the redeposition of dyes in a textile laundering wash bath from coloured textiles onto white or differently-coloured textiles also present in the same wash bath. The anionically-modified cellulosic polymer is used as a dye transfer inhibitor during a textile laundering process. The anionically-modified cellulosic polymer can be used towards any dye present in the laundering wash bath, but is particularly useful towards direct dyes, acid dyes, vat dyes and sulfur dyes.

Any anionically-modified cellulosic polymer is suitable for use in the present invention. A preferred anionically-modified cellulosic polymer is carboxymethyl cellulose (CMC). A preferred carboxymethyl cellulose has a degree of substitution (DS) of at least 0.55 and has a degree of blockiness (DB) of at least 0.35, and has a DS+DB in the range of from 1.05 to 2.00.

Suitable CMCs may also be additionally modified, for example ether modified carboxymethyl cellulose, ether modified carboxyethyl cellulose, ether modified carboxymethylethyl cellulose, ester modified carboxymethyl cellulose, ester modified carboxy ethylcellulose, ester modified carboxymethylethyl cellulose, amido modified carboxymethyl cellulose, amido modified carboxyethyl cellulose, amido modifed carboxymethylethyl cellulose, and mixtures thereof. Another suitable anionically-modified cellulosic polymer is sulfoethyl cellulose and derivatives thereof.

Examples of suitable polymers are the carboxymethyl cellulose products sold under the tradenames Finnfix® (CP Kelco), Detercel® (Amtex), USK® (USK Kimya), Carbocel® (Lamberti), Mikro-Technik® (Mikro-Technik), Dencell® (Denkim).

Preferably the laundry detergent composition comprises the anionically modified cellulosic polymer at a level between 0.1 percent and 10 percent, preferably between 0.15 percent and 5 percent even more preferably between 0.2 percent and 4 percent, most preferably between 0.25 percent and 3 percent by weight of the laundry detergent composition, specifically reciting all values within these ranges and any ranges created thereby.

Renewable carbon content in polymers may be achieved by specifically formulating with polymers providing such benefit. Some examples include polymers with a polysaccharide backbone, e.g. celluloses, guar gums, starches, polyglucans, inulins, and the like. An additional example includes TexCare® from Clariant.

Regarding the biodegradability of polymers, similar to surfactants, manufacturers of laundry compositions and packaging thereof may require that their products pass the OECD 302B and/or 302C. Some examples of biodegradeable polymers are disclosed in U.S. Patent Application Publication Nos. 2019/0024019; 2020/0362270; 2019/0024018; 2020/0362269; 2021/0395649 and European Patent Application Publication No. 3907270.

### Solvent

The solvent utilized in the laundry compositions of the present disclosure can be organic. Preferably, the organic solvent is selected from alcohols including ethanol, propanol, isopropanol, and mixtures thereof, polyols including sugar alcohols, glycols, glycol ethers, and mixtures thereof, preferably polyethylene glycol especially low molecular weight polyethyleneglycols such as PEG 200 and PEG 400, diethylene glycol, glycerol, 1,2-propanediol, polypropylene glycol including dipropyleneglycol and tripropyleneglycol and low molecular weight polypropyleneglycols such as PPG400, sorbitol, or a mixture thereof. Preferably the organic solvent is formulated between 0.1 percent and 40 percent, more preferably between 0.5 percent and 30 percent, most preferably between 1 percent and 25 percent by weight of the laundry detergent composition, specifically reciting all values within these ranges and any ranges created thereby.

There are solvents available which comprise renewable carbon. Some examples include bio-ethanol, bio-propanediol and glycerol. Still other examples include lactate esters such as ethyl lactate. Additionally, while not comprising renewable carbon, water is also a solvent which does not include nonrenewable carbon.

Regarding biodegradability, solvents are very much like surfactants. For example, manufacturers may require that the laundry compositions and/or packaging pass the OECD 301B Biodegredation Test. From a chemistry standpoint, it is worth noting that linear hydrophobes are readily biodegradable and only some branched hydrophobes are. Quarternary carbons do not degrade. Also, stacked branching on adjacent carbon atoms in an alkyl chain can decrease biodegradability. Some examples of biodegradable solvents include linear alkyl chain solvents with or without ethoxylation, e.g. ethoxylated glycol ether. Additional examples include linear polyols, glycerine and glycerine ethoxylates.

### Chelants

Preferably, the chelant is selected from EDDS, HEDP, GLDA, MGDA, DTPA, DTPMP, DETA, EDTA, or mixtures thereof. Preferably the chelant is formulated between 0.1 percent and 5 percent, more preferably between 0.2 percent and 3 percent by weight of the laundry detergent composition, specifically reciting all values within these ranges and any ranges created thereby.

Regarding renewable carbon, there are a myriad of options for chelants. One example includes sugar derived chelants from Nouryon sold under the trade name Dissolvine®. The Dissolvine® lineup includes a methylglycine N,N-diacetic trisodium salt (MGDA) and a glutamic acid, N,N-diacetic tetrasodium salt (GLDA). Still another example includes Trilon® M Max from BASF which is an MGDA.

Regarding biodegradability of chelants, some suitable examples include nitrilotriacetic acid (NTA), ethylenediaminedisuccinic acid (EDDS), iminodisuccinic acid (IDS), L-glutamic acid, N-N-diacetic acid tetrasodium salt (GLDA) and 2-hydroxyethyliminodi(acetic acid) disodium salt (HEIDA).

### Enzymes

Preferably the enzyme is selected from protease, metalloprotease, amylase, cellulase, mannanase, lipase, xyloglucanase, cutinase, bleaching enzyme including peroxidases and oxidases, pectate lyase, nuclease enzyme, or a mixture thereof. The enzyme can be formulated as a free enzyme, an enzyme granulate, an encapsulated enzyme, or a mixture thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases. Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum. Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. anuginosus). The lipase may be a “first cycle lipase”. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark. Other suitable lipases include: Liprl 139, and TfuLip2.

Other enzymes: Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™. Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Enzymes are typically produced through fermentation, i.e. bacterial processes, so they are renewable.

Regarding enzymes utilized specifically for cold water or shorter wash cycle applications, they are preferably selected from the group consisting of aminopeptidase, amylase, arabinase, alginate lyase, carbohydrase, carboxypeptidase, catalase, cellulase, chitinase, cutinase, cyclodextrin glycosyltransferase, deoxyribonuclease, esterase, galactanase, alpha-galactosidase, beta-galactosidase, glucoamylase, alpha-glucosidase, beta-glucosidase, haloperoxidase, hexosaminidase, invertase, laccase, lipase, mannanase, mannosidase, oxidase such as laccase or peroxidase, pectinolytic enzyme, peptidoglutaminase, peroxidase, phytase, polyphenoloxidase, proteolytic enzyme, ribonuclease, transglutaminase, xylanase, xanthan lyase, xanthanase, endo-β-1,3-glucanase and mixtures thereof. Preferably the cleaning or treatment composition comprises additional enzyme selected from oxidase, protease, cellulase, amylase, hexosaminidase, mannanase, xanthan lyase, xanthanase, and mixtures thereof.

Preferably the composition comprises additional enzymes selected from xanthan lyase, xanthanase, mannanase, hexosaminidase and mixtures thereof. Mannanase is particularly preferred.

The additional enzyme(s) may be produced, for example, by a microorganism belonging to the genus Aspergillus, e.g., Aspergillus aculeatus, Aspergillus awamori, Aspergillus foetidus, Aspergillus fumigatus, Aspergillus japonicus, Aspergillus nidulans, Aspergillus niger, or Aspergillus oryzae; Fusarium, e.g., Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, or Fusarium venenatum; Humicola, e.g., Humicola insolens or Humicola lanuginosa; or Trichoderma, e.g., Trichoderma harzianum, Trichoderma koningii, Trichoderma longibrachiatum, Trichoderma reesei, or Trichoderma viride. These enzymes are further described in a European application no. EP21180900.9 filed on Jun. 22, 2021, entitled “Cleaning or Treatment Compositions Containing Nuclease Enzymes.”

Additional exemplary enzymes include DNase, RNase and Hexosaminadases. Suitable DNases include wild-types and variants of DNases disclosed in WO2017162836 (Novozymes), and variants of the Bacillus cibi DNase including those described in WO2018011277 (Novozymes), incorporated herein by reference. Preferred DNases are as claimed in co-pending European Patent Application No. EP18202967.

RNase: suitable RNases include wild-types and variants of DNases disclosed in WO2018178061 (Novozymes), incorporated herein by reference.

Hexosaminidases: The composition may comprise one or more hexosaminidases. The term hexosaminidase includes “dispersin” and the abbreviation “Dsp”, which means a polypeptide having hexosaminidase activity, EC 3.2.1 .—that catalyzes the hydrolysis of β-1,6-glycosidic linkages of N-acetyl-glucosamine polymers found in soils of microbial origin. The term hexosaminidase includes polypeptides having N-acetylglucosaminidase activity and β-N-acetylglucosaminidase activity. Hexosaminidase activity may be determined according to Assay II described in WO2018184873. Suitable hexosaminidases include those disclosed in WO2017186936, WO2017186937, WO2017186943, WO2017207770, WO2018184873, WO2019086520, WO2019086528, WO2019086530, WO2019086532, WO2019086521, WO2019086526, WO2020002604, WO2020002608, WO2020007863, WO2020007875, WO2020008024, WO2020070063, WO2020070249, WO2020088957, WO2020088958 and WO2020207944. Variants of the Terribacillus saccharophilus hexosaminidase described in WO2020207944 may be preferred, especially the variants with improved thermostability disclosed in that publication.

### Perfumes and Aesthetic Agents

Preferably, the laundry detergent composition comprises one or more perfume raw materials. More preferably the perfume materials can be formulated as free perfume materials, spray-on perfumes, or as part of a perfume delivery system preferably selected from the group consisting of encapsulated perfume materials, perfume loaded zeolites, pro-perfumes, or a mixture thereof. Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof. It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume capsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

From a renewable carbon standpoint, the perfumes in the laundry compositions of the laundry compositions of the present disclosure may comprise essential oils and/or natural oils extracted from plants. The use of natural oils, natural extracts and/or essential oils also allows the perfumes to meet the biodegradability requirements disclosed herein.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. The hueing dye is preferably selected from the group consisting of direct violet 9, direct violet 66, direct violet 99, acid red 50, solvent violet 13, and mixtures thereof. Suitable hueing agents include phthalocyanine and azo dye conjugates. Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, and/or alkoxylated thiophene azo dyes. The hueing agent may be incorporated into the detergent composition as is in dissolved form, as a hueing dye particle, or as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route.

Suitable leuco compounds include leuco compounds comprising a leuco moiety and an alkyleneoxy moiety covalently bound to the leuco moiety, wherein the alkyleneoxy moiety comprises at least one ethylene oxide group and at least one propylene oxide group. Preferred leuco compounds include those conforming to the structure of Formula LI,

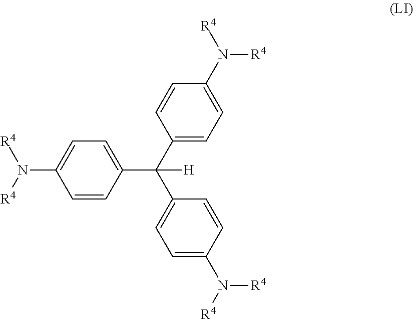

wherein each R⁴ is independently selected from the group consisting of H, Methyl, Ethyl, ((CH₂CH₂O)ₐ(C₃H₆O)_{b})H, autoxidation products of ((CH₂CH₂O)ₐ(C₃H₆O)_{b})H comprising an —OOH or —OH group replacing a H atom at a carbon atom adjacent to an ether oxygen or resulting in a chain terminating with a group selected from H, C(O)CH₃, C(O)H, COOH, CH₂C(O)H, CH₂COOH, CH₂C(O)CH₃, CH(CH₃)C(O)H, (CH(CH₃)COOH), and mixtures thereof; preferably at least one R⁴ group is ((CH₂CH₂O)ₐ(C₃H₆O)_{b})H; wherein each index a is independently an integer from 1-100, each index b is independently an integer from 0-50, and wherein the sum of all the independently selected a integers in all R⁴ groups is no more than 200, preferably no more than 100, and the sum of all the independently selected b integers in all R⁴ groups is no more than 100, preferably no more than 50. Preferably at least two R⁴ groups are selected from Methyl and Ethyl, most preferably at least one N in structure LI is substituted with two R⁴ groups selected from Methyl and Ethyl, preferably Me. R⁴ groups that are ((CH₂CH₂O)ₐ(C₃H₆O)_{b})H comprising an —OOH or —OH group replacing a H atom at a carbon atom adjacent to an ether oxygen or resulting in a chain terminating with a group selected from H, C(O)CH₃, C(O)H, COOH, CH₂C(O)H, CH₂COOH, CH₂C(O)CH₃, CH(CH₃)C(O)H, and (CH(CH₃)COOH) may be intentionally included via the synthesis route, or they may be the inevitable result of the well-known autoxidation of polyoxyalkylene chains. Not every possible minor product arising from autoxidation of the polyoxyalkylene chains is explicitly listed here, because the autoxidation of polyoxyalkylene chains is part of the common general knowledge known to those skilled in the art. See, for example, Stability of the Polyoxyethylene Chain, Chapter 18, Nonionic Surfactants: Physical Chemistry, Surfactant Science Series, Vol. 23, pp. 1011-1072, or the chapter titled Polyalkylene Glycols in Synthetic Lubricants and High-Performance Functional Fluids, 2nd Edition, pp. 159-193, which cites European Polymer Journal, 1993, Vol. 29(2-3), pp. 437-442 regarding “The autoxidation of poly(propylene oxides)”. Highly preferred leuco compounds include those conforming to the structure of Formula LII,

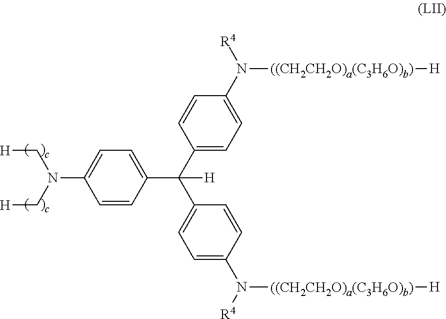

wherein each index c is independently 0, 1 or 2, preferably each c is 1; each R⁴ is independently selected from the group consisting of H, Me, Et, ((CH₂CH₂O)ₐ(C₃H₆O)_{b})H, autoxidation products of ((CH₂CH₂O)ₐ(C₃H₆O)_{b})H comprising an —OOH or —OH group replacing a H atom at a carbon atom adjacent to an ether oxygen or resulting in a chain terminating with a group selected from H, C(O)CH₃, C(O)H, COOH, CH₂C(O)H, CH₂COOH, CH₂C(O)CH₃, CH(CH₃)C(O)H, (CH(CH₃)COOH), and mixtures thereof; preferably each R⁴ is ((CH₂CH₂O)ₐ(C₃H₆O)_{b})H wherein each index a is independently an integer from 1-50, more preferably 1-25, even more preferably 1-20, 1-15, 1-10, 1-5 or even 1-2; each index b is independently an integer from 0-25, more preferably 0-15, even more preferably 1-5 or even 1-3 and wherein the sum of all the independently selected a integers in the leuco compound is no more than 100, more preferably no more than 80, most preferably no more than 60, 40, 20, 10 or even no more than 5, and the sum of all the independently selected b integers in the leuco compound is no more than 50, more preferably no more than 40, most preferably no more than 30, 20, or even 10. In a particularly preferred aspect, each index c is 1, each R⁴ is ((CH₂CH₂O)ₐ(C₃H₆O)_{b})H, each index a is an integer from 1-5, each index b is an integer from 1-5, the sum of all the independently selected a integers in the leuco compound is from 4 to 10, and the sum of all the independently selected b integers in the leuco compound is from 5 to 15.

In another aspect, highly preferred leuco compounds include those conforming to the structure of Formula (LIII),

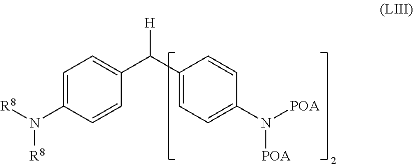

wherein R⁸ is H or CH₃, each POA (polyoxyalkylene) group is independently selected from the group consisting of CH₂CH₂O(C₃H₆O)_{b}H, autoxidation products of CH₂CH₂O(C₃H₆O)_{b})H comprising an —OOH or —OH group replacing a H atom at a carbon atom adjacent to an ether oxygen or resulting in a chain terminating with a group selected from H, C(O)CH₃, C(O)H, COOH, CH₂C(O)H, CH₂COOH, CH₂C(O)CH₃, CH(CH₃)C(O)H, (CH(CH₃)COOH), and mixtures thereof, and each index b is independently on average about 1 to 2.

Leuco compositions containing leuco compounds conforming to the structures of Formula LI, LII, and LIII are expected by those skilled in the art to contain minor impurities arising from autoxidation of the polyoxyalkylene chains as disclosed above. Such impurities are contemplated to be part of the leuco composition.

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN. Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)];amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms. Most preferably the brightener is selected from the group consisting of di-styryl biphenyl compounds, di-amino stilbene di-sulfonic acid compounds, Pyrazoline compounds, coumarin compounds, and mixtures thereof, such as C.I. fluorescent brightener 260, C.I. fluorescent brightener 351, FWA49, FWA15, FWA36, and mixtures thereof.

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland). Most preferably the dye transfer inhibitor is selected from the group consisting of polyamine N-oxide polymers, copolymers of N-vinylpyrrolidone and N-vinylimidazole, polyvinylpyrrolidone, polyvinyloxazolidone, polyvinylimidazole and mixtures thereof, preferably poly(vinyl pyrrolidone), poly(vinylpyridine betaine), poly(vinylpyridine N-oxide), poly(vinyl pyrrolidone-vinyl imidazole), and mixtures thereof.

In some forms, the laundry composition of the present disclosure may comprise an opacifier such as that commercially available from Dow Inc. under the trade name Acusol. Regarding renewable carbon content, the dyes of the laundry compositions of the present disclosure may comprise natural dyes or colorants derived from plants, invertebrates and/or minerals. Many natural dyes may be derived from plant sources, e.g. roots, berries, bark, leaves, wood, fungi, and the like.

### Builders

Preferably the laundry detergent composition comprises a builder, preferably wherein the builder is selected from the group consisting of zeolite builder preferably zeolite A, zeolite P, zeolite MAP, or mixtures thereof, phosphate builder preferably sodium tri-polyphosphate, citrate builder, or mixtures thereof. Preferably the builder is formulated between 0.1 percent and 20 percent, preferably between 0.5 percent and 10 percent by weight of the laundry detergent composition, specifically reciting all values within these ranges and any ranges created thereby.

Preferably the laundry detergent comprises an inorganic carbonate salt, preferably wherein the inorganic carbonate salt is selected from sodium carbonate, sodium bicarbonate, or mixtures thereof. Preferably the inorganic carbonate salt is formulated between 0.1 percent and 30 percent, preferably between 0.5 percent and 25 percent by weight of the laundry detergent composition, specifically reciting all values within these ranges and any ranges created thereby.

Preferably the laundry detergent comprises a silicate salt, preferably wherein the silicate salt is a sodium silicate salt, more preferably sodium silicate salts having a Na2O:SiO2 ratio of from 1.0 to 2.8, preferably from 1.6 to 2.0. Preferably the silicate salt is formulated between 0.1 percent and 20 percent, preferably between 1 percent and 15 percent by weight of the laundry detergent composition, specifically reciting all values within these ranges and any ranges created thereby.

Preferably the laundry detergent comprises an inorganic sulphate salt, preferably wherein the inorganic sulphate salt is sodium sulphate. Preferably the inorganic sulphate salt is formulated between 10 percent and 70 percent, preferably between 20 percent and 50 percent by weight of the laundry detergent composition, specifically reciting all values within these ranges and any ranges created thereby.

Regarding the renewable carbon content, builders may comprise fatty acids or citric acid. The fatty acids may be derived from palm kernel.

From a biodegradability standpoint, some of the prior examples may be utilized. Some examples of biodegradable builders include naturally derived fatty acids and citric acid.

### Bleaching System

Preferably the laundry detergent comprises a bleaching system, preferably wherein the bleaching system comprises a hydrogen peroxide source, a bleach activator, a bleach catalyst, a pre-formed peracid, a reducing bleach, a photobleach, or a mixture thereof.

Preferably the hydrogen peroxide source is selected from the group consisting of perborate salts, percarbonate salts, or mixtures thereof, preferably sodium perborate, sodium percarbonate, or a mixture thereof. Preferably the hydrogen peroxide source is formulated between 1 percent and 25 percent, preferably between 5 percent and 20 percent, by weight of the laundry detergent composition, specifically reciting all values within these ranges and any ranges created thereby.

Preferably the bleach activator is selected from tetra acetyl ethylene diamine, alkyl oxybenzene sulphonate, or a mixture thereof. Preferably the bleach activator is formulated between 1 percent and 8 percent, preferably between 2 percent and 6 percent, by weight of the laundry detergent composition, specifically reciting all values within these ranges and any ranges created thereby.

Preferably the bleach catalyst is selected from the group consisting of oxaziridinium bleach catalysts, transition metal bleach catalysts preferably manganese and iron bleach catalysts, or a mixture thereof. Preferably the bleach catalyst has a structure corresponding to general formula below:

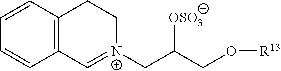

wherein R13 is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Preferably the bleach catalyst is formulated between 0.1 percent and 1 percent by weight of the laundry detergent composition, specifically reciting all values within these ranges and any ranges created thereby.

Preferably the pre-formed peracid includes phthalimido-peroxycaproic acid. Preferably the preformed peracid or the reducing bleach is formulated between 1 percent and 10 percent, specifically reciting all values within these ranges and any ranges created thereby.

Preferably the photobleach is selected from zinc sulphonated phtalocyanine, aluminium sulphonated phtalocyanine, and mixtures thereof. Preferably the photobleach is formulated between 0.01 percent and 0.1 percent by weight of the laundry detergent composition, specifically reciting all values within these ranges and any ranges created thereby.

From a carbon footprint standpoint, bleaching systems may comprise bleaching enzymes which are naturally derived. Bleaching enzymes are known in the art. Also, geologically derived components in the bleaching system may be replaced with hydrogen peroxide.

### Flocculant

Preferably the laundry detergent composition comprises a flocculant, preferably wherein the flocculant is polyethylene oxide. Preferably the flocculant is formulated between 0.01 percent and 1 percent by weight of the laundry detergent composition, specifically reciting all values within these ranges and any ranges created thereby. One example of a flocculant which relies on a renewable carbon source is chitosan.

### Fabric Softener

Preferably the laundry detergent composition comprises a fabric softener, preferably wherein the fabric softener is selected from montmorillonite clay, polydimethylsiloxane (PDMS), or a mixture thereof. Preferably the fabric softener is formulated between 1 percent and 15 percent by weight of the laundry detergent composition, specifically reciting all values within these ranges and any ranges created thereby. From a renewable carbon standpoint, mineral clays rather than ester quats may be utilized.

### Adjuncts

Some additional components in the laundry compositions of the present disclosure include antioxidants, antibacterial components, anti-mite components, preservatives, structurants, anti-foam components, electrolytes, pH trimming components, and alkanolomines.

Antioxidants include sulfite salts such as potassium sulphite or potassium bisulphite salts and those commercially available under the Ralox brandname. From a renewable carbon standpoint, the antioxidants may be naturally derived. Some examples include vitamin C (ascorbic acid) and vitamin E (tocopherols). Gallic acid may similarly be naturally derived.

Antibacterial components and anti-viral agents may include 4.4′-dichloro 2-hydroxydiphenyl ether such as Tinosan HP100 available from the BASF company. From a renewable carbon standpoint, these components may comprise essential oils included in herbal pharmacopoeias, e.g. natural oils of bay, cinnamon, clove and thyme. Another possible antibacterial component is coconut oil. Additional examples include organic acids which may be derived from renewable carbon resources, e.g. lactic acid.

Anti-mite components may comprise benzyl benzoate. Benzyl benzoate may be derived from reacting sodium benzoate with benzoic acid. The benzoic acid may be naturally derived which can allow for the anti-mite components to at least comprise partial renewable carbon content.

Preservatives may be naturally derived. As an example, organic acids such as lactic acid, benzoic acid, and sorbic acid may be utilized as preservatives and may also be sourced from renewable carbon resources.

Additional adjunct ingredients include structuring agents including hydrogenated castor oil, silicone based anti-foam materials, and electrolytes including inorganic electrolytes such as sodium chloride, potassium chloride, magnesium chloride, and calcium chloride, and related sodium, potassium, magnesium and calcium sulphate salts, as well as organic electrolytes such as sodium, potassium, magnesium and calcium salts of carbonate, bicarbonate, carboxylates such as formate, citrate and acetate.

Any ingredients described herein may be added to the liquid detergent composition as an individual material, an aqueous or organic solvent-based solution, or pre-formulated as a premix comprising multiple individual materials.

Potential of hydrogen (pH) trimming agents may comprise components derived from renewable carbon sources and/or components that reduce the carbon footprint thereof. Some examples of suitable pH trimming agents include hydrogen chloride and hydrogen fluoride, ammonia or sodium hydroxide, potassium hydroxide, naturally derived citric acid, naturally derived organic acid, sorbic acid, and lactic acid.

Preferably, the liquid laundry detergent composition has a pH between 6 and 10, more preferably between 6.5 and 8.9, most preferably between 7 and 8, wherein the pH of the liquid laundry detergent composition is measured as a 10 percent dilution in demineralized water at 20° C.

Preferably, the granular laundry detergent composition has a pH between about 2.0 and about 12.0 or more preferably between about 2.7 and about 10.5, specifically reciting all values within these ranges and any ranges created thereby, wherein the pH of the granular laundry detergent composition is measured as a 10 percent dilution in demineralized water at 20° C. In one particular example, the granular laundry detergent may have a pH from between about 6.0 to about 10.5.

The liquid laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition. When Newtonian, the composition may have a viscosity value, at a shear rate of 20 s⁻¹ and a temperature of 20° C., of 100 to 3,000 cP, alternatively 200 to 2,000 cP, alternatively 300 to 1,000 cP, following the method described herein. When non-Newtonian, the composition may have a high shear viscosity value, at a shear rate of 20 s⁻¹ and a temperature of 20° C., of 100 to 3,000 cP, alternatively 300 to 2,000 cP, alternatively 500 to 1,000 cP, and a low shear viscosity value, at a shear rate of 1 s⁻¹ and a temperature of 20° C., of 500 to 100,000 cP, alternatively 1000 to 10,000 cP, alternatively 1,300 to 5,000 cP, following the method described herein. Methods to measure viscosity are known in the art. According to the present disclosure, viscosity measurements are carried out using a rotational rheometer, e.g. TA instruments AR550. The instrument includes a 40 mm 2° or 1° cone fixture with a gap of around 50-60 μιη for isotropic liquids, or a 40 mm flat steel plate with a gap of 1000 μιη for particles containing liquids. The measurement is carried out using a flow procedure that contains a conditioning step, a peak hold and a continuous ramp step. The conditioning step involves the setting of the measurement temperature at 20° C., a pre-shear of 10 seconds at a shear rate of 10 s1, and an equilibration of 60 seconds at the selected temperature. The peak hold involves applying a shear rate of 0.05 s1 at 20° C. for 3min with sampling every 10 s. The continuous ramp step is performed at a shear rate from 0.1 to 1200 s1 for 3 min at 20° C. to obtain the full flow profile.

### Water-Soluble Unit Dose Article

A further aspect of the present invention is a water-soluble unit dose article comprising the laundry detergent composition according to the present invention. Preferably, the water-soluble unit dose article comprises a water-soluble film. Additionally, the water-soluble unit dose articles may comprise liquid laundry compositions, granular laundry detergent compositions, or combinations thereof. The liquid and granular laundry detergent compositions utilized may be those described herein. The water-soluble film is described in greater detail herein.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

In some forms, the first water-soluble film may be selected such that it dissolves faster than the second water-soluble film. For example, the first and second water-soluble film may differ in film thickness and/or film chemistry such that a difference in dissolution speed is enabled.

The compartment should be understood as meaning a closed internal space within the unit dose article, which holds the laundry detergent composition. During manufacture, a first water-soluble film may be shaped to comprise an open compartment into which the laundry detergent composition is added. A second water-soluble film is then laid over the first water-soluble film in such an orientation as to close the opening of the compartment. The first and second water-soluble films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article may comprise three films, top, middle and bottom. Such configurations may be achieved via processing or such configurations may be achieved via folding the unit dose article such that one compartment is superjacent to another compartment.

Alternatively, the compartments may be positioned in a side-by-side orientation, i.e. one orientated next to the other when placed on a flat surface. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the laundry detergent composition according to the present invention may be comprised in at least one of the compartments. It may for example be comprised in just one compartment, or may be comprised in two compartments, or even in three compartments. In some forms, the water-soluble unit dose article may comprise at least two internal compartments, wherein the laundry detergent composition is comprised in at least one of the compartments, preferably wherein the unit dose article comprises at least three compartments, wherein the laundry detergent composition is comprised in at least one of the compartments.

Each compartment may comprise the same or different compositions. The different compositions could all be in the same form, or they may be in different forms, e.g. liquid, gel, paste, powder, or mixtures thereof.

### Water-Soluble Film

The water-soluble film of the present invention is soluble or dispersible in water. The water-soluble film preferably has a thickness of from 20 to 150 microns, preferably 35 to 125 microns, even more preferably 50 to 110 microns, most preferably about 76 microns.

Preferably, the water-soluble film has a water-solubility of at least 50 percent, preferably at least 75 percent or even at least 95 percent, as measured by the method set out here after using a glass-filter with a maximum pore size of 20 microns. The percent water-solubility can be determined via the method below. Five grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, injection molding, thermoforming, extrusion or blown extrusion of the polymeric material, as known in the art. Preferred films are those supplied by Mono sol under the trade references M8630, M8900, M8779, M8310.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. The polymer can have any weight average molecular weight, preferably from about 1000 to 1,000,000, more preferably from about 10,000 to 300,000 yet more preferably from about 20,000 to 150,000.

Preferably, the water-soluble film comprises at least one polyvinyl alcohol homo polymer and/or at least one polyvinyl alcohol copolymer, preferably a blend of polyvinylalcohol homopolymers and/or polyvinylalcohol copolymers, wherein the polyvinyl alcohol copolymer is preferably selected from sulphonated and carboxylated anionic polyvinylalcohol copolymers especially carboxylated anionic polyvinylalcohol copolymers, most preferably the water-soluble film comprises a blend of a polyvinylalcohol homopolymer and a carboxylated anionic polyvinylalcohol copolymer, or a blend of two polyvinyl alcohol homopolymers. The water-soluble polymer may be present between 50 percent and 95 percent, preferably between 55 percent and 90 percent, more preferably between 60 percent and 80 percent by weight of the water-soluble film, specifically reciting all values within these ranges and any ranges created thereby.

Where a desire to increase the bio-content of the water-soluble unit dose article, the water-soluble film may or at least a portion thereof may be substituted with film made from a casein polymer. As an example, where a plurality of layers of water-soluble film, e.g. three, are utilized to form the soluble unit dose, one or more of the layers of water-soluble film may comprise a casein polymer film.

Preferably, the water-soluble film comprises a non-aqueous plasticizer. Preferably, the non-aqueous plasticizer is selected from polyols, sugar alcohols, and mixtures thereof. Suitable polyols include polyols selected from the group consisting of glycerol, diglycerin, ethylene glycol, diethylene glycol, triethyleneglycol, tetraethylene glycol, polyethylene glycols up to 400 MW, neopentyl glycol, 1,2-propylene glycol, 1,3-propanediol, dipropylene glycol, polypropylene glycol, 2-methyl-1,3-propanediol, trimethylolpropane and polyether polyols, or a mixture thereof. Suitable sugar alcohols include sugar alcohols selected from the group consisting of isomalt, maltitol, sorbitol, xylitol, erythritol, adonitol, dulcitol, pentaerythritol and mannitol, or a mixture thereof. More preferably the non-aqueous plasticizer is selected from glycerol, 1,2-propanediol, dipropylene glycol, 2-methyl-1,3-propanediol, trimethylolpropane, triethyleneglycol, polyethyleneglycol, sorbitol, or a mixture thereof, most preferably selected from glycerol, sorbitol, trimethylolpropane, dipropylene glycol, and mixtures thereof. One particularly suitable plasticizer system includes a blend of glycerol, sorbitol and trimethylol propane. Another particularly suitable plasticizer system includes a blend of glycerin, dipropylene glycol, and sorbitol. Preferably, the water-soluble film comprises between 5 percent and 50 percent, preferably between 10 percent and 40 percent, more preferably between 20 percent and 30 percent by weight of the water-soluble film of the non-aqueous plasticizer, specifically reciting all values within these ranges and any ranges created thereby.

Preferably, the water-soluble film comprises a surfactant. Preferably, the water-soluble film comprises a surfactant in an amount between 0.1 percent and 2.5 percent, preferably between 1 percent and 2 percent by weight of the water-soluble film, specifically reciting all values within these ranges and any ranges created thereby. Suitable surfactants can include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Other suitable surfactants include dioctyl sodium sulfosuccinate, lactylated fatty acid esters of glycerol and propylene glycol, lactylic esters of fatty acids, sodium alkyl sulfates, polysorbate 20, polysorbate 60, polysorbate 65, polysorbate 80, lecithin, acetylated fatty acid esters of glycerol and propylene glycol, and acetylated esters of fatty acids, and combinations thereof.

Preferably the water-soluble film according to the invention comprises lubricants/release agents. Suitable lubricants/release agents can include, but are not limited to, fatty acids and their salts, fatty alcohols, fatty esters, fatty amines, fatty amine acetates and fatty amides. Preferred lubricants/release agents are fatty acids, fatty acid salts, and fatty amine acetates. the amount of lubricant/release agent in the water-soluble film is in a range of from 0.02 percent to 1.5 percent, preferably from 0.1 percent to 1 percent by weight of the water-soluble film, specifically reciting all values within these ranges and any ranges created thereby.

Preferably, the water-soluble film comprises fillers, extenders, antiblocking agents, detackifying agents or a mixture thereof. Suitable fillers, extenders, antiblocking agents, detackifying agents or a mixture thereof include, but are not limited to, starches, modified starches, crosslinked polyvinylpyrrolidone, crosslinked cellulose, microcrystalline cellulose, silica, metallic oxides, calcium carbonate, talc and mica. Preferred materials are starches, modified starches and silica. Preferably, the amount of filler, extender, antiblocking agent, detackifying agent or a mixture thereof in the water-soluble film is in a range of from 0.1 percent to 25 percent, preferably from 1 percent to 10 percent, more preferably from 2 percent to 8 percent, most preferably from 3 percent to 5 percent by weight of the water-soluble film, specifically reciting all values within these ranges and any ranges created thereby. In the absence of starch, one preferred range for a suitable filler, extender, antiblocking agent, detackifying agent, or a mixture thereof is from 0.1 percent to 1 percent, preferably 4 percent, more preferably 6 percent, even more preferably from 1 percent to 4 percent, most preferably from 1 percent to 2.5 percent, by weight of the water-soluble film, specifically reciting all values within these ranges and any ranges created thereby.

Preferably the water-soluble film according to the invention has a residual moisture content of at least 4 percent, more preferably in a range of from 4 percent to 15 percent, even more preferably of from 5 percent to 10 percent by weight of the water-soluble film as measured by Karl Fischer titration, specifically reciting all values within these ranges and any ranges created thereby.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50 percent, preferably at least 75 percent or even at least 95 percent, as measured by the method set out here after using a glass-filter with a maximum pore size of 20 microns, described above.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000rpm, specifically reciting all values within these ranges and any ranges created thereby.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins, or mixtures thereof.

As noted previously, articles in accordance with the present disclosure include water-soluble foam, fibers or sheets. The water-soluble foam, fiber or sheet may comprise a water-soluble fibrous structure and one or more particles distributed throughout the structure. The water-soluble fibrous structure may comprise one or a plurality of fibrous elements that are different from one another. Non-limiting examples of differences in the fibrous elements may be physical differences, such as differences in diameter, length, texture, shape, rigidness, elasticity, and the like; chemical differences, such as crosslinking level, solubility, melting point, Tg, active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element is exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. Two or more fibrous elements within the fibrous structure may comprise different active agents. This may be the case where the different active agents may be incompatible with one another, for example an anionic surfactant and a cationic polymer. When using different fibrous elements, the resulting structure may exhibit different wetting, imbibitions, and solubility characteristics.

The fibrous water-soluble unit dose article may exhibit different regions, such as different regions of basis weight, density, caliper, and/or wetting characteristics. The fibrous water-soluble unit dose article may be compressed at the point of edge sealing. The fibrous water-soluble unit dose article may comprise texture on one or more of its surfaces. A surface of the fibrous water-soluble unit dose article may comprise a pattern, such as a non-random, repeating pattern. The fibrous water-soluble unit dose article may comprise apertures. The fibrous water-soluble unit dose article may comprise a fibrous structure having discrete regions of fibrous elements that differ from other regions of fibrous elements in the structure. The fibrous water-soluble unit dose article may be used as is or it may be coated with one or more active agents.

The fibrous water-soluble unit dose article may comprise one or more plies. The fibrous water-soluble unit dose article may comprise at least two and/or at least three and/or at least four and/or at least five plies. The fibrous plies can be fibrous structures. Each ply may comprise one or more layers, for example one or more fibrous element layers, one or more particle layers, and/or one or more fibrous element/particle mixture layers. The layer(s) may be sealed. In particular, particle layers and fibrous element/particle mixture layers may be sealed, such that the particles do not leak out. The water-soluble unit dose articles may comprise multiple plies, where each ply comprises two layers, where one layer is a fibrous element layer and one layer is a fibrous element/particle mixture layer, and where the multiple plies are sealed (e.g., at the edges) together. Sealing may inhibit the leakage of particles as well as help the unit dose article maintain its original structure. However, upon addition of the water-soluble unit dose article to water, the unit dose article dissolves and releases the particles into the wash liquor.

The fibrous elements and/or particles may be arranged within the water-soluble unit dose article, in a single ply or in multiple plies, to provide the article with two or more regions that comprise different active agents. For example, one region of the article may comprise bleaching agents and/or surfactants and another region of the article may comprise softening agents.

Water-soluble articles in accordance with the present disclosure along with particles and/or added compositions are described in additional detail in the disclosures of U.S. Patent Application Publication nos. 2018/0216052A1; 2018/0216050A1; 2018/0216053A1; and 2022/0119744A1; incorporated by reference in their entirety.

### Process of Making

A further aspect of the present invention is a process of making a laundry detergent composition or a water-soluble unit dose article according to the present invention. The laundry detergent compositions can be prepared by creating a slurry of components of the laundry detergent of the present disclosure. The components may be added individually to the slurry or may be batched together as there can be a multitude of components included within the slurry. One component includes alkoxylated alkyl sulphate, alkyl sulphate, or mixtures thereof. The alkyl sulphate and/or alkoxylated alkyl sulphate can be derived from natural alcohols, synthetic alcohols, or mixtures thereof. Examples of alcohol sources were described previously under the surfactant section.

Additional components that can be added to the slurry include at least one adjunct ingredient, wherein the adjunct ingredient is preferably selected from fatty acids, non-aqueous solvents, water, pH trimming agents, preservatives, or a mixture thereof. Components of the laundry detergent composition of the present disclosure which can be added to the slurry include: linear alkylbenzene sulphonate, alkoxylated alcohol (synthetic, natural, or mixtures thereof); additional surfactants comprising at least one of cationic surfactant, amphoteric surfactant, zwitterionic surfactant, or a mixture thereof; amphiliphilic graft polymer; ethoxylated polyethyleneimine; amphiphilic alkoxylated polyethyleneimine; a tri-block copolymer; zwitterionic polyamine; polyester terephthalate; cationic polymer; carboxylate polymer; anionically modified cellulosic polymer; perfume and/or perfume capsules; organic solvent; chelant; enzyme(s) and/or enzyme capsules; dye(s) including hueing dyes, leuco dyes, opacifiers, or mixtures thereof; brightener; dye transfer inhibitor; builder; inorganic carbonate salt, silicate salt, inorganic sulfate salt, or a combination thereof; anti-oxidant, bleaching system; flocculant; and fabric softener, and (pre-)mixtures thereof.

### Process for Making the Granular Composition

Typically, the particles of the composition can be prepared by any suitable method. For example: spray-drying, agglomeration, extrusion, and any combination thereof. A suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

The spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt percent of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process. Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt percent of the agglomerates have a particle size less than 150 micrometers and less than 10 wt percent of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Preferably, following addition of all ingredients, the final laundry detergent composition, the unit dose article comprising the laundry detergent composition according to the present invention, or a mixture thereof, is treated to reduce dioxane levels, preferably wherein said treatment comprises stripping, distillation, evaporation, centrifugation, microwave irradiation, molecular sieving, catalytic degradation step, enzymatic degradation step or a mixture thereof.

### Packaging

The laundry compositions of the present disclosure can be enclosed in a packaging having one or more of the following properties:
a) a recycled content of at least 25 percent, preferably at least 50 percent, more preferably at least 75 percent, most preferably 100 percent by weight of the packaging;
b) compliance with recycling stream requirements, i.e. comprising a recyclable content of greater than 50 percent, preferably more than 60 percent or more than 70 percent or more than 80 percent or more than 90 percent or even more than 95 percent by weight of the packaging of a main packaging material, while comprising less than 50 percent preferably less than 40 percent, or less than 30 percent or less than 20 percent or less than 10 percent or even less than 5 percent by weight of the packaging of secondary packaging materials.

The packaging may be made from any suitable material. The packaging may be made of natural materials, synthetic materials, or a mixture thereof. The packaging may be made from materials comprising recycled materials. The packaging may comprise metallic materials, plastic materials, paper-based materials, bio-based material, bamboo fibres, cellulose fibres, cellulose based or fibre-based materials, or a mixture thereof.

The packaging may be made from a plastic material, preferably a polyolefin material. For example, the packaging may be made from polypropylene (PP), polystyrene (PS), polyethylene (PE), high-density polyethylene (HDPE), polyethylene terephthalate (PET), polyvinyl chloride (PVC), Acrylonitrile Butadiene Styrene (ABS), Polycarbonates (PC), Polyamides (PA), recycled versions thereof, or a mixture thereof. Preferably, the packaging may be made from polypropylene, polystyrene, high-density polyethylene, polyethylene terephthalate, recycled versions thereof, or a mixture thereof. The plastic material may have a tensile modulus ranging from 1250 MPa to 3000 MPa, preferably between 1300 MPa and 2300 MPa. Those skilled in the art will know how to measure tensile modulus using techniques commonly known in the art.

The packaging may be made from metallic materials wherein the metallic material is preferably selected from aluminium, steel, or a mixture thereof.

The packaging may be made from paper materials wherein the paper material is preferably selected from cardboard, laminates, cellulose pulp materials, or a mixture thereof. The paper-based materials may comprise plain board-based materials, corrugated cardboard-based materials, or mixtures thereof. The packaging may comprise a corrugated cardboard container comprising a laminated plastic layer such as a laminated PE layer. The packaging may comprise a plain board paper bag with a laminated PE inner layer, preferably wherein the PE inner layer has been obtained from a renewable source, as described before.

The packaging may comprise a main container enclosing the laundry detergent composition or the water-soluble unit dose articles, and a closure system. The closure system may be selected from a valve, a cap, a lid, a hinged lid, a sleeve, or a mixture thereof. The closure system may be a child deterrent or a child resistant closure mechanism. Preferably the container including the closure mechanism are based on renewable components, preferably selected from paper based materials including plain board, cardboard, or mixtures thereof, optionally laminated with a PE layer to improve protection against moisture and leakage.

In some examples, the opening of the packaging is provided after removal of a tamper proof feature, for example comprising a perforated piece to be removed at first use. A tamper evident sticker may be locking a packaging, for example a lid to the box. In some examples a tamper evident sticker is glued on the lid and on the box, whereby the tamper evident sticker should be broken, teared or perforated at first opening to indicate to a consumer that the container has not been tempered with before purchase. This temper evident sticker may for example be in paper or in plastic.

The material used to make the packaging may comprise other ingredients, such as colorants, preservatives, plasticisers, UV stabilizers, Oxygen, neat perfume and/or perfume embedded in a hot melt adhesive, recycled materials and moisture barriers, or a mixture thereof. The packaging may comprise areas of external or internal printing, or may comprise a printed label.

The packaging may be made using any suitable process. Suitable processes include but are not limited to thermoforming, injection molding, injection stretch blow molding, extrusion blow molding, or a mixture thereof preferably thermoforming or injection molding, or a mixture thereof. Further suitable processes include, but or not limited to, tube forming from a flat laminate with a welding step, extruded tube forming, folding from a flat blank, or a mixture thereof.

The packaging may be opaque, translucent, transparent, or a mixture thereof. Preferably, the packaging is opaque.

### Consumer Ingredient Preference

Despite the safe and effective use of components in laundry compositions, the laundry compositions of the present disclosure may be formulated in order to appease consumer demand for the absence of certain components. Also, regulators are becoming more stringent on what materials can be used to what level inside such laundry detergent composition. For example, the laundry compositions of the present disclosure may comprise less than 1 percent, preferably less than 0.5 percent, more preferably less than 0.1 percent or even less than 0.01 percent by weight of the individual components, pre-mixes or final formulations, most preferably is free of components (non-detectable levels) that have one or more of the following classifications:
(a) CMR (carcinogenic, mutagenic, reprotoxic) category 1A, 1B or 2;
(b) Endocrine Disruptor category 1;
(c) PBT (Persistent Bioaccumulative & Toxic) or vPvB (very Persistent very Bioaccumulative);
(d) Potentially PMT (Persistent, Mobile and Toxic)/vPvM (very Persistent very Mobile);
(e) Respiratory and/or Skin Sensitizer;
(f) STOT (Specific Target Organ Toxicity); and
(g) Neuro and Immuno-Toxicant.

Additionally, laundry compositions of the present disclosure may comprise (at the levels shown below) or may be free (non-detectable levels) of one or more of the following ingredients:
(h) between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppm and 100 ppb dioxane, most preferably 0 ppm dioxane, wherein the dioxane includes 1,2-dioxane, 1,3-dioxane, 1,4-dioxane, derivatives of 1,2-dioxane, 1,3-dioxane, 1,4-dioxane including dimethyl dioxane derivatives of 1,2-dioxane, 1,3-dioxane, 1,4-dioxane, or a mixture thereof, preferably 1,4-dioxane;
(i) between 0 ppm and 50 ppm, preferably between 0 ppm and 15 ppm, more preferably between 0 ppm and 1.5 ppm, most preferably is free of isothiazolinone based preservatives;
(j) less than 1 percent, preferably less than 0.5 percent, more preferably less than 0.1 percent or even less than 0.01 percent, by weight of the individual ingredients pre-mixes or final formulations, most preferably is free of perfume materials selected of alkyl cyclic ketone perfume materials, especially free of OTNE (1-(1,2,3,4,5,6,7,8-octahedro-2,3,8,8-tetramethyl-2-naphtalenyl) ethenone) material, butylphenylmethylpropional (a.k.a. lily aldehyde, lysmeral or Lilial), or mixtures thereof;
(k) less than 1 percent, preferably less than 0.1 percent, more preferably less than 0.01 percent, by weight of the individual component pre-mixes or final formulations, most preferably is free of microplastics;
(l) comprises less than 1 percent, preferably less than 0.5 percent, more preferably less than 0.3 percent or even less than 0.1 percent, by weight of the individual component pre-mixes or final formulations, most preferably is free of borates, especially sodium tetraborate, sodium metaborate, or mixtures thereof;
(m) comprises less than 1 percent, preferably less than 0.5 percent, more preferably less than 0.3 percent or even less than 0.1 percent, by weight of the individual component pre-mixes or final formulations, most preferably is free of quaternary ammonia compounds.

### Dioxane Scavenger

As noted previously, consumers may not desire dioxane, regardless of level, to be present in the laundry compositions of the present disclosure. Dioxane scavengers included in the laundry compositions of the present disclosure can help immobilize the dioxane to reduce exposure, reduce the level of dioxane and in some instances eliminate dioxane from said laundry compositions. Preferably, the dioxane scavenger is selected from 5,6-dihydro-3-(4-morpholinyl)-1-[4-(2-oxo-1-piperidinyl) phenyl]-2(1H)-pyridone, 3a-hydroxy-7-oxo-mixture of cholanic acid, 3-(N-methyl amino)-L-alanine, and mixtures thereof. Preferably, the liquid laundry detergent composition according to the present invention is made via a process comprising a step of treating the liquid laundry detergent composition to reduce dioxane, wherein the dioxane is reduced by stripping, distillation, evaporation, centrifugation, microwave irradiation, molecular sieving, catalytic degradation step, enzymatic degradation step, or a mixture thereof, most preferably stripping.

Combatting the dioxane is not trivial. The dioxane can be present within any of the starting materials or intermediates as a by-product of the targeted molecule synthesis or could have been introduced as an impurity within diluting water or non-aqueous solvent introduction or any other individual material introduced within the targeted raw material. A dioxane reduction processes can be applied on the final liquid laundry detergent formulations, any intermediate formulation, or any individual raw material used to prepare the liquid detergent formulation. For example, the alkyl sulphate, alkoxylated alkyl sulphate, or a mixture thereof, and/or the slurry, may be treated to reduce dioxane levels, preferably wherein said treatment comprises stripping, distillation, evaporation, centrifugation, microwave irradiation, molecular sieving, catalytic degradation step, enzymatic degradation step, or a mixture thereof, more preferably stripping, most preferably a multiple stripping step.

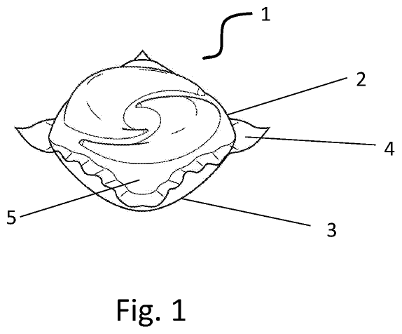

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

### Soluble Unit Dose Laundry Formulation

The following is a multi-compartment water soluble unit dose laundry article comprising a larger bottom compartment while having two smaller compartments in a side-by-side configuration superposed on top of the bottom compartment, following the Ariel 3-in-1 Pods design, as commercially available in the UK in January 2022. The below compositions are enclosed in a polyvinyl alcohol-based water-soluble film, more specifically a water-soluble film comprising a blend of a polyvinyl alcohol homopolymer and a carboxylated anionic polyvinyl alcohol copolymer for the outer films, and a water-soluble film comprising a blend of a polyvinyl alcohol homopolymers for the middle film.

| | | Bottom | Top | Top |
|---|---|---|---|---|
| | Full article | compartment | compartment | compartment |
| | Composition | Composition | Composition 1 | Composition 2 |
| Ingredients | (wt %) | (wt %) | (wt %) | (wt %) |
| Volume | 25.5 ml | 22.3 ml | 1.6 ml | 1.6 ml |
| Fatty alcohol ethoxylate non- | 3.5 | 3.7 | 2.6 | 1.6 |
| ionic surfactant, C₁₂₋₁₄ average | | | | |
| degree of ethoxylation of 7 | | | | |
| Lutensol XL100 | 0.4 | 0.5 | — | — |
| Linear C₁₁₋₁₄ alkylbenzene | 24.2 | 24.9 | 18.9 | 19.4 |
| sulphonate | | | | |
| AE3S Ethoxylated alkyl | 12.3 | 12.6 | 9.7 | 9.7 |
| sulphate with an average degree | | | | |
| of ethoxylation of 3 | | | | |
| Citric acid | 0.7 | 0.7 | 0.5 | 0.5 |
| Palm Kernel Fatty acid | 5.2 | 5.4 | 4.1 | 4.1 |
| Nuclease enzyme* (wt % active | 0.009 | 0.011 | — | — |
| protein) | | | | |
| Protease enzyme (wt % active | 0.05 | 0.06 | — | — |
| protein) | | | | |
| Amylase enzyme (wt % active | 0.004 | 0.005 | — | — |
| protein) | | | | |
| Xyloglucanese enzyme (wt % | 0.005 | — | 0.073 | — |
| active protein) | | | | |
| Mannanase enzyme (wt % active | 0.003 | 0.003 | — | — |
| protein) | | | | |
| Lipase enzyme (wt % active | 0.012 | — | 0.187 | — |
| protein) | | | | |
| Ethoxylated polyethyleneimine | 1.5 | 1.6 | 1.2 | 1.2 |
| Amphiphilic graft copolymer | 2.0 | 2.3 | — | — |
| Zwitterionic polyamine | 1.8 | 1.9 | 1.4 | 1.4 |
| Anionic polyester terephthalate | 0.4 | — | — | 5.8 |
| HEDP | 2.2 | 2.2 | 1.7 | 1.7 |
| Brightener 49 | 0.3 | 0.4 | 0.01 | 0.01 |
| Silicone anti-foam | 0.3 | 0.3 | — | — |
| Hueing dye | 0.04 | — | 0.69 | — |
| 1,2 PropaneDiol | 13.6 | 12.8 | 11.3 | 26.4 |
| Glycerine | 6.0 | 5.0 | 17.3 | 8.3 |
| DPG (DiPropyleneGlycol) | 0.8 | 0.8 | 0.6 | 0.6 |
| TPG (TriPropyleneGlycol) | 0.06 | 0.06 | — | — |
| Sorbitol | 0.6 | 0.05 | 8.8 | — |
| Monoethanolamine | 10.0 | 10.4 | 7.9 | 8.0 |
| K2SO3 | 0.4 | 0.4 | 0.04 | 0.4 |
| MgCl2 | 0.3 | 0.3 | 0.2 | 0.2 |
| water | 10.9 | 10.9 | 11.8 | 9.9 |
| Hydrogenated castor oil | 0.1 | 0.1 | — | 0.1 |
| Perfume | 1.6 | 1.9 | — | — |
| Aesthetic dye & Minors (incl. | Balance | Balance | Balance | Balance |
| preservative) | to 100 | to 100 | to 100 | to 100 |
| pH (10% product concentration | 7.4 | 7.4 | 7.4 | 7.4 |
| in demineralized water at 20° C.) | | | | |

*Nuclease enzyme is as claimed in co-pending European application 19219568.3

### Liquid Laundry Formulation

| | Composition | Composition | Composition |
|---|---|---|---|
| Raw Material | A | B | C |
| NI C24 EO9 | 8.7 | 8.7 | 8.7 |
| NIC45 EO7 | 2.7 | 2.7 | 2.7 |
| C 12/14 Amine Oxide | 1.0 | 1.0 | 1.0 |
| C 11.8 HLAS | 11.8 | 11.8 | 11.8 |
| C13 Branched Alkyl | 10.3 | — | 5.1 |
| Sulfate (Example 4)¹ | | | |
| C15 Branched Alkyl | — | 10.3 | 5.1 |
| Sulfate (Example 3)² | | | |
| Citric Acid | 2.3 | 2.3 | 2.3 |
| Chelating Agent³ | 0.65 | 0.65 | 0.65 |
| Mannanase | 0.0017 | 0.0017 | 0.0017 |
| Pectawash | 0.00342 | 0.00342 | 0.00342 |
| Amylase | 0.00766 | 0.00766 | 0.00766 |
| Protease | 0.07706 | 0.07706 | 0.07706 |
| Sodium Chloride | 0.023 | 0.023 | 0.023 |
| Sodium Tetraborate | 1.7 | 1.7 | 1.7 |
| Calcium Formate | 0.18 | 0.18 | 0.18 |
| Sodium Formate | 0.074 | 0.074 | 0.074 |
| Ethoxylated | 1.7 | 1.7 | 1.7 |
| Polyethyleneimine⁴ | | | |
| Ethoxylated | 1.8 | 1.8 | 1.8 |
| Propoxylated | | | |
| polyethyleneimine | | | |
| Flourescent | 0.22 | 0.22 | 0.22 |
| Brightener⁵ | | | |
| Preservative 1⁶ | 0.001 | 0.001 | 0.001 |
| Preservative 2⁷ | 0.002 | 0.002 | 0.002 |
| Sorbitol | 0.071 | 0.071 | 0.071 |
| Ethanol | 1.9 | 1.9 | 1.9 |
| 1,2 Propylene Glycol | 5.5 | 5.5 | 5.5 |
| Sodium cumene | 1.7 | 1.7 | 1.7 |
| sulfonate | | | |
| Monoethanolamine | 3.5 | 3.5 | 3.5 |
| Sodium Hydroxide | 0.016 | 0.016 | 0.016 |
| Suds suppressor 1⁸ | 0.004 | 0.004 | 0.004 |
| Hydrogenated Castor | 0.082 | 0.082 | 0.082 |
| Oil | | | |
| Suds suppressor 2⁹ | 0.2 | 0.2 | 0.2 |
| Hueing dye¹⁰ | 0.03 | 0.03 | 0.03 |
| Aesthetic dye | 0.01 | 0.01 | 0.01 |
| Fragrance | 1.3 | 1.3 | 1.3 |
| Water & Minors | Balance | Balance | Balance |
| | to 100% | to 100% | to 100% |

1 C13 Branched Alkyl Sulfate (Example 4) is described in WO2021/247801, in relevant part, under the heading “Example 4. Synthesis of Narrow Branched Tridecanol (C13) Sulfate using a Falling Film Sulfation Reactor (Inventive Example 4).”
2 C15 Branched Alkyl Sulfate (Example 3) is described in WO2021/247801, in relevant part, under the heading “Example 3. Synthesis of Narrow Branched Pentadeconal (C15) Sulfate using a Falling Film Sulfation Reactor (Inventive Example 3).”
3 Chelating agent is diethylenetriaminepentaacetic acid
4 PE-20 commercially available from BASF
5 Fluorescent Brightener is disodium 4,4′-bis{[4-anilino-6-morpholino-s-triazin-2-yl]-amino}-2,2′-stilbenedisulfonate preservative 2 is Phenoxyethanol
6 Preservative 1 is BIT commercially available from Lonza as Proxel
7 Preservative 2 is Phenoxyethanol
8 Suds suppressor 1 is DC1520 commercially available from Dow Coming
9 Suds suppressor 2 is AF-8017 commercially available from Dow
10 Hueing dye is Liquitint Violet 200 commercially available from Milliken

### Granular Laundry Formulation

### Solid Free-Flowing Particulate Laundry Detergent Composition Examples

| Ingredient | Amount (in wt %) |
|---|---|
| Anionic detersive surfactant (such as alkyl benzene | from 8 wt % to 15 wt % |
| sulphonate, alkyl ethoxylated sulphate and mixtures thereof) | |
| Non-ionic detersive surfactant (such as alkyl ethoxylated | from 0.1 wt % to 4 wt % |
| alcohol) | |
| Cationic detersive surfactant (such as quaternary | from 0 wt % to 4 wt % |
| ammonium compounds) | |
| Other detersive surfactant (such as zwiterionic detersive | from 0 wt % to 4 wt % |
| surfactants, amphoteric surfactants and mixtures thereof) | |
| Carboxylate polymer (such as co-polymers of maleic acid | from 0.1 wt % to 4 wt % |
| and acrylic acid and/or carboxylate polymers comprising | |
| ether moieties and sulfonate moieties) | |
| Polyethylene glycol polymer (such as a polyethylene glycol | from 0 wt % to 4 wt % |
| polymer comprising polyvinyl acetate side chains) | |
| Polyester soil release polymer (such as Repel-o-tex and/or | from 0 wt % to 2 wt % |
| Texcare polymers) | |
| Cellulosic polymer (such as carboxymethyl cellulose, methyl | from 0.5 wt % to 2 wt % |
| cellulose and combinations thereof) | |
| Other polymer (such as care polymers) | from 0 wt % to 4 wt % |
| Zeolite builder and phosphate builder (such as zeolite 4A | from 0 wt % to 4 wt % |
| and/or sodium tripolyphosphate) | |
| Other co-builder (such as sodium citrate and/or citric acid) | from 0 wt % to 3 wt % |
| Carbonate salt (such as sodium carbonate and/or sodium | from 0 wt % to 20 wt % |
| bicarbonate) | |
| Silicate salt (such as sodium silicate) | from 0 wt % to 10 wt % |
| Filler (such as sodium sulphate and/or bio-fillers) | from 10 wt % to 70 wt % |
| Source of hydrogen peroxide (such as sodium percarbonate) | from 0 wt % to 20 wt % |
| Bleach activator (such as tetraacetylethylene diamine | from 0 wt % to 8 wt % |
| (TAED) and/or nonanoyloxybenzenesulphonate (NOBS)) | |
| Bleach catalyst (such as oxaziridinium-based bleach catalyst | from 0 wt % to 0.1 wt % |
| and/or transition metal bleach catalyst) | |
| Other bleach (such as reducing bleach and/or pre-formed | from 0 wt % to 10 wt % |
| peracid) | |
| Photobleach (such as zinc and/or aluminium sulphonated | from 0 wt % to 0.1 wt % |
| phthalocyanine) | |
| Chelant (such as ethylenediamine-N′N′-disuccinic acid | from 0.2 wt % to 1 wt % |
| (EDDS) and/or hydroxyethane diphosphonic acid (HEDP)) | |
| Hueing agent (such as direct violet 9, 66, 99, acid red 50, | from 0 wt % to 1 wt % |
| solvent violet 13 and any combination thereof) | |
| Brightener (C.I. fluorescent brightener 260 or C.I. | from 0.1 wt % to 0.4 wt % |
| fluorescent brightener 351) | |
| Protease (such as Savinase, Savinase Ultra, Purafect, FN3, | from 0.1 wt % to 0.4 wt % |
| FN4 and any combination thereof) | |
| Amylase (such as Termamyl, Termamyl ultra, Natalase, | from 0 wt % to 0.2 wt % |
| Optisize, Stainzyme, Stainzyme Plus and any combination | |
| thereof) | |
| Cellulase (such as Carezyme and/or Celluclean) | from 0 wt % to 0.2 wt % |
| Lipase (such as Lipex, Lipolex, Lipoclean and any | from 0 wt % to 1 wt % |
| combination thereof) | |
| Other enzyme (such as xyloglucanase, cutinase, pectate | from 0 wt % to 2 wt % |
| lyase, mannanase, bleaching enzyme) | |
| Fabric softener (such as montmorillonite clay and/or | from 0 wt % to 15 wt % |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 4 wt % |
| Perfume (such as perfume microcapsule, spray-on perfume, | from 0.1 wt % to 1 wt % |
| starch encapsulated perfume accords, perfume loaded zeolite, | |
| and any combination thereof) | |
| Aesthetics (such as coloured soap rings and/or coloured | from 0 wt % to 1 wt % |
| speckles/noodles) | |
| Miscellaneous | balance to 100 wt % |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition, wherein; the laundry detergent composition, individual components and/or created premixes thereof, and mixtures thereof, to make the laundry detergent composition, has one or more of the following properties:
a. from 10 to 100 percent by weight of the laundry detergent composition, individual components and/or created premixes thereof, and mixtures thereof, of carbon-containing ingredients, wherein the carbon associated with those ingredients comprises from about 10 percent by weight of the carbon associated with the laundry detergent composition, individual components and/or created premixes thereof, and mixtures thereof of renewable carbon.
b. comprises from about 1 percent by weight of the individual ingredients pre-mixes or final formulations of biodegradable components according to OECD readily biodegradable 301 test protocols, preferably the OECD 301B test protocol (OECD (1992), Test No. 301: Ready Biodegradability, OECD Guidelines for the Testing of Chemicals, Section 3, OECD Publishing, Paris;
c. a carbon footprint expressed in kg CO₂/kg of the individual ingredients pre-mixes or final formulations of less than 10 according to ISO14067:2018.
d. comprises or is free of one or more of the following ingredients:
i. comprises between 0 ppm dioxane, wherein the dioxane comprises 1,2-dioxane, 1,3-dioxane, 1,4-dioxane, derivatives of 1,2-dioxane, 1,3-dioxane, 1,4-dioxane including dimethyl dioxane derivatives of 1,2-dioxane, 1,3-dioxane, 1,4-dioxane, or a mixture thereof, preferably 1,4-dioxane;
ii. Comprises between 0 ppm and 1.5 ppm, most of isothiazolinone based preservatives;
iii. Comprises less than 1 percent by weight of the individual ingredients pre-mixes or final formulations, most preferably is free of perfume materials selected of alkyl cyclic ketone perfume materials, especially free of OTNE (1-(1,2,3,4,5,6,7,8-octahedro-2,3,8,8-tetramethyl-2-naphtalenyl) ethenone) material, butylphenylmethylpropional (a.k.a. lily aldehyde, lysmeral or Lilial), or mixtures thereof;
iv. Comprises less than 1 percent by weight of the individual ingredients pre-mixes or final formulations of microplastics;
v. Comprises less than 1 percent by weight of the individual ingredients pre-mixes or final formulations of borates selected from the group consisting of: sodium tetraborate, sodium metaborate, or mixtures thereof;
vi. Comprises less than 1 percent by weight of the individual ingredients pre-mixes or final formulations of quaternary ammonia compounds.

2. The laundry detergent composition according to claim 1 wherein the laundry detergent composition is selected from a liquid laundry detergent composition, a granular laundry detergent composition, or a mixture thereof.

3. The laundry detergent composition according to claim 2, wherein the laundry detergent is a liquid laundry detergent comprising between 1 percent and 20 percent by weight of the liquid laundry detergent of water.

4. The laundry detergent composition according to claim 3, wherein the laundry detergent composition is in the form of a water-soluble unit dose article.

5. The laundry detergent composition according to claim 4, wherein the water-soluble unit dose article comprises a water-soluble film.

6. The laundry detergent composition according to claim 4, wherein the water-soluble unit dose article comprises water-soluble foam, a plurality of fibers and/or sheets forming a support structure.

7. The laundry detergent composition according to claim 6, wherein the water-soluble unit dose article further comprises an active agent comprising one or more particles distributed throughout the support structure.

8. The laundry detergent composition according to claim 2, wherein the laundry detergent is a liquid laundry detergent comprising greater than 20 percent by weight of the liquid laundry detergent composition of water.

9. A process of making a laundry detergent composition according to claim 1, comprising a step of making a slurry comprising alkyl sulphate, alkoxylated alkyl sulphate, or a mixture thereof.

10. The process of claim 9, wherein the alkyl sulphate, alkoxylated alkyl sulphate, or a mixture thereof and/or the slurry is treated to reduce dioxane, wherein the dioxane is reduced by stripping, distillation, evaporation, centrifugation, microwave irradiation, molecular sieving, catalytic degradation step, enzymatic degradation step, or a mixture thereof.

11. The process for making a laundry detergent composition according to claim 10, comprising a step of adding a linear alkylbenzene sulphonate and/or adding an alkoxylated alcohol, wherein the alkoxylated alcohol is derived from a synthetical alcohol, a natural alcohol, or a mixture thereof.

12. The process according to claim 9 comprising the step of adding a dioxane scavenger, wherein the dioxane scavenger is preferably selected from 5,6-dihydro-3-(4-morpholinyl)-1-[4-(2-oxo-1piperidinyl) phenyl]-2(1H)-pyridone, 3a-hydroxy-7-oxo-mixture of cholanic acid, 3-(N-methyl amino)-L-alanine, and mixtures thereof.

13. A process of making the laundry composition according to claim 2, wherein the laundry detergent is in granular form, wherein the process is selected from the group consisting of spray-drying, agglomeration, extrusion, and any combination thereof.

14. The process according to claim 13, wherein the agglomeration process comprises the step of contacting a detersive ingredient, preferably a detersive surfactant, with an inorganic material, or a mixture thereof, in a mixer.

15. The process according to claim 9, wherein the laundry detergent composition is treated to reduce dioxane levels, wherein said treatment comprises stripping, distillation, evaporation, centrifugation, microwave irradiation, molecular sieving, catalytic degradation step, enzymatic degradation step, or a mixture thereof.

16. The process according to claim 15, wherein the treatment step comprises stripping and wherein the stripping step is repeated at least twice.

17. The process according to claim 14, wherein the laundry detergent composition is treated to reduce dioxane levels, wherein said treatment comprises stripping, distillation, evaporation, centrifugation, microwave irradiation, molecular sieving, catalytic degradation step, enzymatic degradation step, or a mixture thereof.

18. The process according to claim 17, wherein the treatment step comprises stripping and wherein the stripping step is repeated at least twice.

19. The process according to claim 10, wherein a perfume or fragrance is added to the dioxane treated alkyl sulphate, alkoxylated alkyl sulphate, a mixture thereof and/or the slurry.

20. The process according to claim 15, wherein a perfume or fragrance is added to the dioxane treated laundry detergent composition.

21. A packaging for enclosing the laundry detergent composition according to claim 1, wherein the packaging has one or more of the following properties:
a recycled content of at least 25 percent by weight of the packaging;
compliance with recycling stream requirements, wherein the packaging comprises recyclable material content of greater than 50 percent by weight of the packaging of a main packaging material, while comprising less than 50 percent by weight of the packaging of secondary packaging materials.

22. The packaging according to claim 21, wherein the packaging comprises metallic materials, plastic materials, paper-based materials, or a mixture thereof.

23. The packaging according to claim 22, wherein the plastic materials comprise a polyolefin material selected from at least one of polypropylene (PP), polystyrene (PS), polyethylene (PE), high-density polyethylene (HDPE), polyethylene terephthalate (PET), polyvinyl chloride (PVC), Acrylonitrile Butadiene Styrene (ABS), Polycarbonates (PC), Polyamides (PA), recycled versions thereof, or a mixture thereof.

24. The packaging according to claim 22 wherein the paper-based materials comprise plain board-based materials, corrugated cardboard based materials, or mixtures thereof.
